(19) United States
(12) Patent Application Publication
(10) Pub. No.: US 2021/0042671 A1
(43) Pub. Date: Feb. 11, 2021

(54) SYSTEMS AND METHODS FOR AUTOMATED HIGHWAY RESERVATION

(71) Applicant: Blissway Inc., Bakersfield, CA (US)

(72) Inventors: Francisco Torrealba Fuenzalida, Bakersfield, CA (US); Felipe Ignacio Kettlun Chomali, Menlo Park, CA (US)

(21) Appl. No.: 16/988,590

(22) Filed: Aug. 7, 2020

Related U.S. Application Data
(60) Provisional application No. 62/883,793, filed on Aug. 7, 2019.
(60) Provisional application No. 62/990,365, filed on Mar. 16, 2020.
(60) Provisional application No. 62/959,671, filed on Jan. 10, 2020.
(60) Provisional application No. 63/000,982, filed on Mar. 27, 2020.

(51) Int. Cl. G06Q 10/02; G06Q 10/04; G06Q 30/02; G06Q 50/30; G07B 15/06; G01C 21/34; G08G 1/01

(52) U.S. Cl. CPC G06Q 10/02; G06Q 10/047; G06Q 30/0284; G06Q 2240/00; G07B 15/06; G01C 21/3461; G08G 1/0125; G06Q 50/30

(57) ABSTRACT

The systems and methods described herein provide for an automated highway reservation platform which allows for users to reserve travel of a vehicle along a route to their destination. In one embodiment, the system receives, on a client device associated with a user, a travel destination and a user location. The system then determines an optimal route to the destination from the user's location, and identifies one or more highway sections that are reservable along the optimal route. The system determines a price estimate for reserving the highway sections in order for the user to travel in a vehicle along the optimal route. The system receives an acceptance of the price estimate from the client device, and then reserves the one or more highway sections for the user based on the price estimate.

### CROSS-REFERENCE TO RELATED APPLICATIONS

This application claims the benefit of U.S. Provisional Application No. 62/883,793 filed Aug. 7, 2019, U.S. Provisional Application No. 62/990,365, filed on Sep. 13, 2019, U.S. Provisional Application No. 62/959,671, filed Jan. 10, 2020 and U.S. Provisional Application No. 63/000,982, filed on Mar. 27, 2020, which are all hereby incorporated by reference in their entirety.

### FIELD

The presently described systems and methods relate generally to the field of traffic engineering, and more particularly, to providing systems and methods for automated highway reservation, vehicle occupancy verification, and determination of dynamic toll pricing.

### BACKGROUND

It is a major challenge of traffic engineers to design highway systems in such a way that they do not suffer from a breakdown in the smooth flow of traffic, i.e., traffic congestion. Even the world's best-regarded tolled highways and implementations of managed lanes—also known as High Occupancy Toll (HOT) lanes or express lanes—are subject to this problem. This is because traffic management is generally reactive to what is occurring on the highway, such as a decrease in the average speed of vehicles or an increase in vehicle density on the highway which signals traffic congestion. In response to the increased traffic, for example, a highway tolling system may be designed to increase pricing to dissuade new vehicles from entering the highway, thereby alleviating traffic congestion. Once the system reacts to the passive info of the decreased speed of vehicles or increase in traffic density, however, it is already too late to effectively counter the problem of traffic congestion.

For example, the best traffic management systems currently available involve dynamic pricing. This works by having engineers in a control room who are able to more or less manually analyze camera data in real-time and assess appropriate prices based on average speed of the highway, traffic density, and other metrics. While this may be effective, it requires a significant amount of human effort and expense, as well as heavy infrastructure requiring a large number of devices mounted on overhead gantries. In addition, this still confronts the problem of reacting to traffic conditions, rather than predicting them and modifying pricing before congestion occurs.

An improved system is one which predicts the flow of traffic over a given period of time, rather than reacting to the flow of traffic. Highway reservation and lane booking systems are a promising way of attempting this.

Thus, there is a need in the field of traffic engineering to create a new and useful system and method for providing automated reservation of highways and highway lanes based on dynamic pricing. The source of the problem, as discovered by the inventors, is a lack of intelligent, automated mechanics within a highway reservation platform.

### SUMMARY

The systems and methods described herein provide for an automated highway reservation platform which allows for users to reserve travel of a vehicle along a route to their destination. In one embodiment, the system receives, on a client device associated with a user, a travel destination and a user location. The system then determines an optimal route to the destination from the user's location, and identifies one or more highway sections that are reservable along the optimal route. The system determines a price estimate for reserving the highway sections in order for the user to travel in a vehicle along the optimal route. The system receives an acceptance of the price estimate from the client device, and then reserves the one or more highway sections for the user based on the price estimate.

In some embodiments, the system monitors the travel of the vehicle along the optimal route, via the client device. Based on this monitoring, the system receives route usage data based on the monitoring of the travel, and generates aggregate route usage data based on the received route usage data as well as additional route usage data from a number of additional client devices. In some embodiments, this aggregate route usage data is used to determine a future price estimate for reserving the highway sections. In some embodiments, the aggregate route usage data is used to predict future traffic conditions along the route at a given time, and then a future price estimate is determined for that time based on the predicted traffic conditions.

In some embodiments, the system provides for vehicle occupancy verification, as will be described below in further detail.

In some embodiments, the system provides for determination of dynamic toll pricing, as will be described below in further detail.

The features and components of these embodiments will be described in further detail in the description which follows. Additional features and advantages will also be set forth in the description which follows, and in part will be implicit from the description, or may be learned by the practice of the embodiments.

### BRIEF DESCRIPTION OF THE DRAWINGS

FIG. 1A is a diagram illustrating an exemplary environment of a highway reservation system in which some embodiments may operate.

FIG. 1B is a diagram illustrating an exemplary computer system of a highway reservation system that may execute instructions to perform some of the methods therein.

FIG. 2A is a flow chart illustrating an exemplary method of a highway reservation system that may be performed in accordance with some embodiments.

FIG. 2B is a flow chart illustrating additional steps of a highway reservation system that may be performed in accordance with some embodiments.

FIG. 3 is a diagram illustrating an example of optimized and unoptimized traffic flow.

FIG. 4A shows an example interface of a reservation platform in accordance with aspects of the present disclosure.

FIG. 4B shows an example interface of a reservation platform in accordance with aspects of the present disclosure.

FIG. 4C shows an example interface of a reservation platform in accordance with aspects of the present disclosure.

FIG. 5A is a diagram illustrating an exemplary environment of a vehicle occupancy verification system in which some embodiments may operate.

FIG. 5B is a diagram illustrating an exemplary computer system of a vehicle occupancy verification system that may execute instructions to perform some of the methods therein.

FIG. 6A is a flow chart illustrating an exemplary method of a vehicle occupancy verification system that may be performed in accordance with some embodiments.

FIG. 6B is a flow chart illustrating additional steps of a vehicle occupancy verification system that may be performed in accordance with some embodiments.

FIG. 7A shows an example interface of an audio-based occupancy verification process in accordance with aspects of the present disclosure.

FIG. 7B shows an example interface of an audio-based occupancy verification process in accordance with aspects of the present disclosure.

FIG. 7C shows an example interface of an audio-based occupancy verification process in accordance with aspects of the present disclosure.

FIG. 7D shows an example interface of an audio-based occupancy verification process in accordance with aspects of the present disclosure.

FIG. 7E shows an example interface of an audio-based occupancy verification process in accordance with aspects of the present disclosure.

FIG. 8A shows an example interface of an image-based occupancy verification process in accordance with aspects of the present disclosure.

FIG. 8B shows an example interface of an image-based occupancy verification process in accordance with aspects of the present disclosure.

FIG. 8C shows an example interface of an image-based occupancy verification process in accordance with aspects of the present disclosure.

FIG. 8D shows an example interface of an image-based occupancy verification process in accordance with aspects of the present disclosure.

FIG. 9A is a diagram illustrating an exemplary environment of a price determination system in which some embodiments may operate.

FIG. 9B is a diagram illustrating an exemplary computer system of a price determination system that may execute instructions to perform some of the methods therein.

FIG. 10 is a flow chart illustrating an exemplary method of a price determination system that may be performed in accordance with some embodiments.

FIG. 11A shows an example interface of a price determination platform in accordance with aspects of the present disclosure.

FIG. 11B shows an example interface of a price determination platform in accordance with aspects of the present disclosure.

FIG. 11C shows an example interface of a price determination platform in accordance with aspects of the present disclosure.

FIG. 11D shows an example interface of a price determination platform in accordance with aspects of the present disclosure.

FIG. 12 is a diagram illustrating an exemplary computer that may perform processing in some embodiments.

### DETAILED DESCRIPTION

In this specification, reference is made in detail to specific examples of the systems and methods. Some of the examples or their aspects are illustrated in the drawings.

For clarity in explanation, the systems and methods herein have been described with reference to specific examples, however it should be understood that the systems and methods herein are not limited to the described examples. On the contrary, the systems and methods described herein cover alternatives, modifications, and equivalents as may be included within their respective scopes as defined by any patent claims. The following examples of the systems and methods are set forth without any loss of generality to, and without imposing limitations on, the claimed systems and methods. In the following description, specific details are set forth in order to provide a thorough understanding of the systems and methods. The systems and methods may be practiced without some or all of these specific details. In addition, well known features may not have been described in detail to avoid unnecessarily obscuring the systems and methods.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

The following generally relates to the systems and methods for providing automated highway reservation.

### Highway Reservation System

### I. Benefits

Various embodiments of the systems and methods described herein can confer a number of benefits over the previous attempts to address the problems elucidated above.

First, some prior systems required mandatory booking of highways or highway lanes. This forces every driver using a highway or lane to reserve a spot beforehand. This is often an unrealistic expectation and increases barriers to adoption and participation. In contrast, some embodiments of the present invention incentivize, rather than force, drivers to reserve beforehand. In various embodiments, this takes the form of additional benefits which are granted to the user if the user reserves beforehand (such as, e.g., lowering prices based on saving time to a destination).

Second, some embodiments of the present invention monitor and collect data regarding the traffic that constitutes reserved highway or lane usage. By tracking the traffic of users via, e.g., a smart device and locational data, the system is able to track the position of individual drivers. In some case, individual vehicles can be tracked before they reach the highway, which helps to better manage traffic throughput and lane capacity.

Third, unlike other reservation systems (e.g., for airplane tickets), drivers are accustomed to a high level of flexibility in their travel and routes, and are unlikely to compromise on those decisions. Thus, some embodiments of the present invention allow for flexibility and the ability to modify and cancel reservations as desired. Early and late arrivals, not showing up, last minute cancellations, and more are possible and accounted for.

Fourth, many prior systems attempt to constrain capacity when a threshold of capacity is reached. Reaching capacity means that the ability to reserve is removed as an option for users. In some embodiments of the present invention, in contrast, capacity is never constrained arbitrarily. Rather, a price is set such that constraints are naturally set based on demand and willingness to pay a given amount, i.e., price escalates sequentially until it dissuades most of the residual demand.

Fifth, in some embodiments, the present invention allows for overselling reservations, such as with typical reservations in the airline industry. This leads to more capacity in the highway. In some instances, users can be paid for agreeing not to use their reservation.

Sixth, in the present invention, the user is incentivized to reserve beforehand, such that they are aware of the price and agree to pay beforehand. This moves the decision of the driver earlier, which allows for more options, and more educated decision making. For example, if a driver has reserved a highway lane but sees on the device while booking that the highway is already too congested, the driver may opt to avoid the highway altogether, thus reducing congestion.

Eighth, based on some embodiments, the present invention allows for predictive, rather than reactive, pricing. If prices are modified only based on what has already happened at the highway, traffic congestion may be unavoidable. In contrast, the present invention allows for pricing based on true customer demand (i.e., people trying to reserve a highway lane), instead of reactive pricing guesswork at the roadway.

Ninth, some embodiments of the present invention allow for better prediction of demand and traffic patterns based on commuters' driving histories. By logging the history of travel commuters over time, traffic management becomes increasingly better at predicting demand. Many drivers will likely have the same or similar patterns over time i.e. commuters. Having that information, and collecting the individual information into an aggregated pool of information, allows the system to improve naturally and in an automated fashion.

Tenth, in some embodiments, carpools and multi-occupancy vehicles are allowed to travel for free or reduced prices in exchange of reserving beforehand. This significantly improves traffic management by incorporating such vehicles into the traffic optimization. Currently, such vehicles are not only insensitive to pricing but are all but invisible to traffic management systems.

Eleventh, some embodiments predefine a certain free flow condition as baseline, say maintaining a minimum speed of 55 MPH at all times. By establishing a certain minimum speed, highway capacity is automatically revealed, which inputs into the traffic management system.

### II. Exemplary Environments

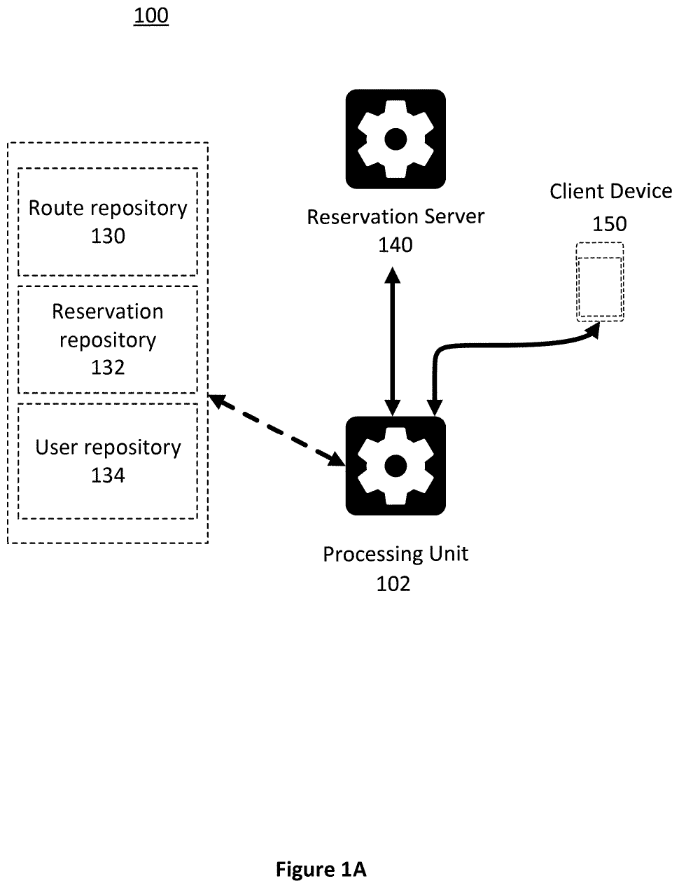

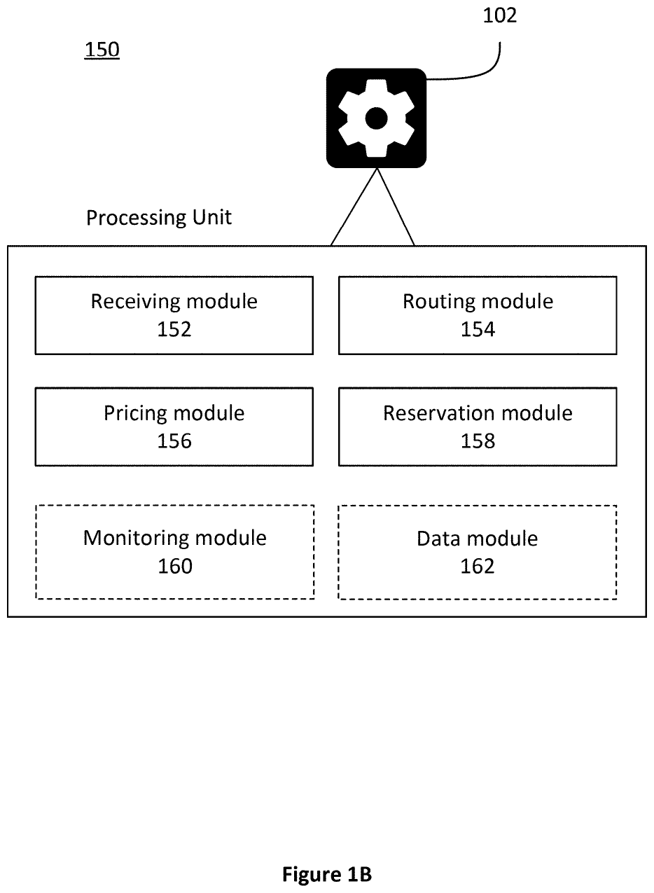

FIG. 1A is a diagram illustrating an exemplary environment in which some embodiments may operate. In the exemplary environment 100, a client device 150 is connected to a processing unit 102. The processing unit 102 is optionally connected to one or more optional database(s), including a route repository 130, reservation repository 132, and/or user repository 134. One or more of the databases may be combined or split into multiple databases. The processing unit 102 is connected to a reservation server 140. The reservation server 140 and/or client device 150 in this environment may be computers.

The exemplary environment 100 is illustrated with only one client device and processing unit for simplicity, though in practice there may be more or fewer client devices and/or processing units. In some embodiments, the client device and processing unit may be part of the same computer or device.

In an embodiment, the processing unit 102 may perform the method 200 or other method herein and, as a result, provide for a highway reservation system. In some embodiments, this may be accomplished via communication with the client device, reservation server 140, and/or other device(s) over a network between the client device 150, reservation server 140, and/or other device(s), application server(s) or other network server(s). In some embodiments, the processing unit 102 is an application hosted on a computer or similar device, or is itself a computer or similar device configured to host an application to perform some of the methods and embodiments herein.

Client device 150 is a device that sends and receives information to the processing unit 102. In some embodiments, client device 150 is a computing device capable of hosting and executing one or more applications or other programs capable of sending and receiving information. In some embodiments, the client device 150 may be a mobile device (such as, e.g., a smart phone or tablet), computer desktop or laptop, on-board vehicle computer (such as, e.g., a smart vehicle), virtual reality or augmented reality device, wearable, or any other suitable device capable of sending and receiving information. In some embodiments, the processing unit 102 may be hosted in whole or in part as an application executed on the client device 150. In some embodiments, client device 150 may have one or more locational sensors, global positioning system (GPS) abilities, or other means of locating a user within a map, environment, roadway or highway system, or any other suitable location.

Reservation server 140 refers to a server in which at least a portion of the processing of the methods described are performed. In varying embodiments, the reservation server 140 can connect and/or authenticate a user within the reservation system, provide reservation processing, manage payments, determine optimal routing, or a number of other aspects of the methods described. In some embodiments, the reservation server 140 is a remote server which the client device 150 and/or processing unit 102 connect to.

Optional database(s) include one or more of a route repository 130, reservation repository 132, and/or user repository 134. These optional databases function to store and/or maintain, respectively, routes and route usage data, reservation data, and user data. Other optional database(s) may be contemplated for other pieces of data throughout the system. In some embodiments, the optional database(s) can be queried by one or more components of system 100 (e.g., by the processing unit 102), and specific stored data in the database(s) can be retrieved.

FIG. 1B is a diagram illustrating an exemplary computer system that may execute instructions to perform some of the methods therein. The diagram shows an example of a processing unit configured to provide a highway reservation system. Processing unit 150 may be an example of, or include aspects of, the corresponding element or elements described with reference to FIG. 1A. In some embodiments, processing unit 150 is a component or system on an enterprise server. In other embodiments, processing unit 150 may be a component or system on client device 120, or may be a component or system on peripherals or third-party devices. Processing unit 150 may comprise hardware or software or both.

In the example embodiment, processing unit 150 includes receiving module 152, routing module 154, pricing module 156, reservation module 158, monitoring module 160, and data module 162.

Receiving module 152 functions to receive data from the client device, reservation server, and/or other devices or computing systems via a network. The data received can include, e.g., instructions or interactions of the user submitted through the client device. In some embodiments, the network may enable transmitting and receiving data from the Internet. Data received by the network may be used by the other modules. The modules may transmit data through the network.

Routing module 154 functions to determine an optimal route to a destination from the user's location.

Pricing module 156 functions to determine a price estimate for reserving one or more highway sections in order for the user to travel in a vehicle along an optimal route. In some embodiments, the pricing module 156 additionally functions to determine a future price estimate based on one or more criteria or pieces of data.

Reservation module 158 functions to reserve the one or more highway sections for the user based on the price estimate. In some embodiments, the reservation module additionally handles payments of reservations.

Optional monitoring module 160 functions to monitor, via the client device, the travel of the vehicle along the optimal route after a reservation has been made.

Optional data module 162 functions to generate route usage data and/or aggregate route usage data.

The above modules will be discussed in further detail with respect to the steps of method 200 below.

### III. Methods

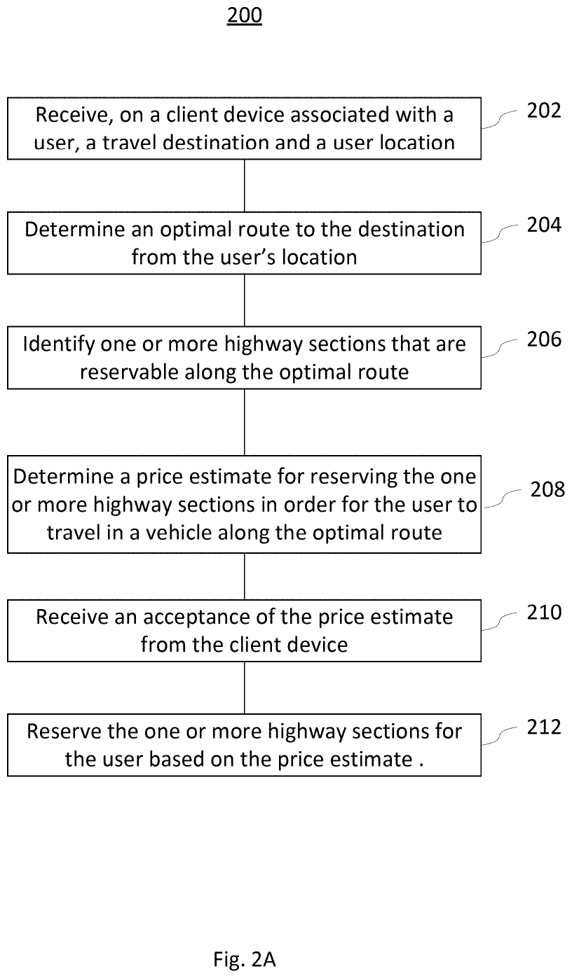

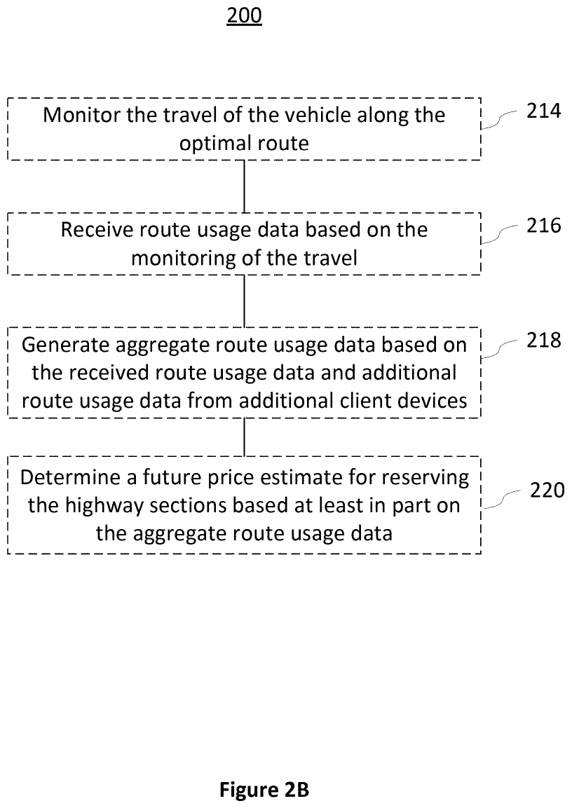

FIG. 2A is a flow chart illustrating an exemplary method that may be performed in accordance with some embodiments. The flow chart shows an example of a process for providing a highway reservation system. In some examples, these operations may be performed by a system including a processor executing a set of codes to control functional elements of an apparatus. Additionally or alternatively, the processes may be performed using special-purpose hardware. Generally, these operations may be performed in accordance with some aspects of the systems and methods herein. For example, the operations may be composed of various substeps, or may be performed in conjunction with other operations described herein.

At step 202, the system receives, on a client device associated with a user, a travel destination and a user location. In some embodiments, the client device is running an application (“app”) which presents a user interface for a highway or lane reservation platform (“highway reservation platform”). Upon executing the application, the user may be prompted to sign onto the highway platform as an existing user or register for a new user account. In some embodiments, authentication and verification are performed on the user before connecting the user to the highway reservation platform. In some embodiments, a connected user is given the option to start a new journey, enter a new destination, or otherwise interact with the application to initiate a reservation.

At step 204, the system determines an optimal route to the destination from the user's location. In some embodiments, the system additionally determines an estimated time to travel along the optimal route to the destination from the user's location. In some embodiments, the system connects to a routing or navigating system or application which is capable of determining the optimal route. Such a navigation system may include a map and/or routing service. In some embodiments, the navigation system may be a first-party system, third-party system, and/or open source service, such as, e.g., Google Maps or OpenMaps. In some embodiments, the reservation system interacts with the navigation system via an Application Programming Interface (API) or other suitable method. The navigation system outputs a best or optimal route to the destination, based on one or more criteria which may be specified by the system and/or user in varying embodiments.

In some embodiments, a user that commutes on a daily or otherwise regular basis may be presented with a user interface button for starting the commute, e.g., a button labeled “Office” or similar. In some embodiments, the application identifies when a user is at home or at their office based on locational data from the client device. An optimal routing from home to commute, or vice versa, may be established via the navigation system in real-time, or may be partly or fully cached. Other commutes or regular trips may be identified, suggested, or entered in by the user. In some embodiments, the user is able to enter into a number of preferences with regard to optimal routing or regular trips.

At step 206, the system identifies one or more highway sections that are reservable along the optimal route. In some embodiments, the system receives a predefined list of highway section that are reservable. The list may be constrained by area or region, may be specific to the user's route, or may be a full list of all reservable highways. In some embodiments, the list may be regularly updated as new highway sections become reservable or existing sections become unreservable. The process of a section of a given highway becoming reservable may be initiated and carried out in any number of ways. For example, one or more representatives of the reservation organization may meet with city or municipality officials to organize reservation of highway sections.

At step 208, the system determines a price estimate for reserving the highway sections in order for the user to travel in a vehicle along the optimal route. A price estimate may be determined in a number of potential ways based on varying embodiments and criteria. In some embodiments, the price estimate may be a cost per time saved, i.e., the amount of time that the vehicle saves by traveling in the reservable highway sections rather than in non-reservable, general purpose highway sections. In some embodiments, the time saved due to traveling along the optimal route in the highway sections that are reservable is compared to traveling along an alternate route in highway sections that are non-reservable, while in other embodiments, the time saved due to traveling along the optimal route in the highway sections that are reservable is compared to traveling along the same optimal route in the highway sections that are non-reservable and general purpose highway sections. In some embodiments, the price estimate may be a cost per unit time, i.e., the amount of time the vehicle spends traveling in the reservable highway sections. In some embodiments, the price estimate may be a cost per unit distance, i.e., the amount of distance the vehicle travels in the reservable highway sections.

In some implementations, the price estimate may be based on the capacity of the roadway and the quantity of vehicles using the roadway or expected to be using the roadway. The system can determine the roadway capacity and quantity of vehicles using a variety of techniques. In some embodiments, such techniques may include tracking the traffic via each client device of multiple users utilizing the system, via locational sensors, GPS, or similar methods. Monitoring and tracking of vehicles will be discussed further below. In some embodiments, the price estimate may be based at least in part on the number of occupants in the vehicle, which will be discussed in further detail below.

In some embodiments, roadway capacity can be determined with respect to a particular segment of the roadway from data obtained by license plate reading devices on that segment which transmit a license plate number to the system each time a vehicle passes it. Such devices can determine the quantity of vehicles using the segment of roadway by tallying the number of independent license plate numbers received from all license plate reading devices on the segment. This data can then be transmitted to the reservation server or client device.

In some embodiments, the system can predict the quantity of vehicles using the highway sections at a future time. In some embodiments, this can be predicted using a model trained on historical data. The quantity of vehicles may be dependent on, e.g., the time of day, day of week, month of the year, whether there are one or more traffic accidents, whether any events are taking place nearby, and any other suitable factors. Such factors may be inputs to the prediction model.

In some embodiments, the model may be an artificial intelligence (“AI”) model. In some embodiments, the AI model may be a machine learning (“ML”) model. The ML model may be a supervised, semi-supervised, or unsupervised ML model. A supervised ML model can be trained on labeled training inputs, i.e., training inputs with known outputs. The training inputs for a traffic model may be the factors mentioned above, and the labels may be derived from historical traffic data. The training inputs can be provided to an untrained or partially trained version of the ML model to generate a predicted output. The predicted output can be compared to the known output, and if there is a difference, the parameters of the ML model can be updated. The supervised ML model may be a neural network (e.g., a feedforward neural network, a convolutional neural network (“CNN”), a recurrent neural network (“RNN”), a regression model, a decision tree, or the like). A semi-supervised ML algorithm can be trained using a large number of unlabeled training inputs and a small number of labeled training inputs. An unsupervised ML algorithm, e.g., a clustering or dimensionality reduction algorithm, can find previously unknown patterns (e.g., traffic patterns) in data sets without pre-existing labels.

In some embodiments, at least one of the highway sections which are reservable can include one or more reservable lanes. These may be, e.g., “priority lanes” which give priority access to users or vehicles that have reserved them. This is in contrast to “general purpose” lanes which are non-reservable and open to general use for any vehicle using the roadway. In some embodiments, the price estimate is determined based on reserving at least one of the reservable lanes in the highway sections. In some embodiments, this may in turn be determined based, at least in part, on estimated time saved due to traveling along the optimal route in reservable lanes of the highway sections compared to traveling along the optimal route (or in other embodiments, an alternate route) in non-reservable lanes of the highway sections. Generally, reservable highway sections as described throughout may also refer to one or more reservable lanes within highway sections, in addition to one or more reservable highways as a whole.

In some embodiments, the cost to use the highway sections, or priority lanes of the highway sections, may be based on a dynamic pricing policy. That is, the cost may be higher when there are a large number of requests to reserve the highway sections from users of the reservation system, and lower when there are a smaller number of requests to reserve the highway sections. In other embodiments, the cost to use the highways sections may instead be a flat or static cost, i.e., not based on the quantity of vehicles traveling on the roadway, nor the demand to reserve highway sections.

In some embodiments, the system provides an estimate of the total price of the trip along the optimal route. The estimate may be, e.g., a cost per unit time or cost per unit distance of the trip multiplied by the predicted time or distance of the trip, adjusted for any of the above-mentioned factors (e.g., quantity of occupants in the vehicle, time of day, or any other suitable factor).

At step 210, the system receives an acceptance of the price estimate from the client device. In some embodiments, this may be an indication that the user has accepted the price estimate. In some embodiments, the acceptance is sent from the client device of the user, via the reservation application installed on the client device. In some embodiments, the system responds by providing an indication that the user is permitted to use the one or more highway sections that were reserved.

In some embodiments, a payment process may be initiated upon the user accepting the price estimate. In other embodiments, the payment process must be completed as a prerequisite to accepting the price estimate. In other embodiments, the payment process will only be initiated upon completion of the trip, e.g., once the user reaches the destination and the trip is over. In varying embodiments, if the payment is initiated upon completion of the trip, the payment may be calculated to be the same as the price estimate; a lower price than the price estimate, e.g., if time saved was less than the system anticipated, or some other factor led to a lower price; or in some cases, a higher price than the price estimate, e.g., if the user opted to take a different route than the optimal route while still using some or all of the reserved highway sections, or if the user traveled in reservable highway sections that hadn't been reserved. The payment process may be initiated by directing the user toward a first-party or third-party payment system, such as, e.g., an e-commerce digital storefront or e-commerce payment service. In some embodiments, the user stores payment information within the user account of the reservation platform. The payment information may be retrievable via the reservation server, one or more optional database(s), locally on the client device, or any other suitable method for retrieving stored payment information. Alternately, a form of payment such as debit or credit card or special reservation card may be used for purposes of payment, and a personal identification number (PIN) card number, or similar must be entered into the application on the client device. A large number of potential embodiments for payment of the price estimate may be contemplated.

At step 212, the system reserves the one or more highway sections for the user based on the price estimate. In some embodiments, the system processes the reservation by associating the user and the user account with a list or database of reservations for each of the highway sections (or highway lanes) which have been reserved by the user. The database may be a reservation repository or similar database. In some embodiments, the system sends notification to the client app that the reservations have been placed and that the trip may begin. In some embodiments, the reservation application begins navigation for the user to direct the user along the optimal route.

In some embodiments, after a reservation has been made, the user may have one or more options to request a modification for the reservation. This may be, e.g. a modification of the reserved highway sections, the destination, a cancellation of the trip, a re-routing based on user's preferences for the route, or any other suitable aspect of the reservation. For example, a user may decide not to take the trip at all, or take public transportation instead, effectively becoming a “no show” for the reservation. In some embodiments, the system allows for such cancellations. In some embodiments, no fee is charged for the cancellations as they are an aspect of driver behavior which is to be expected and is built into the reservation system. In some embodiments, one or more aspects of the reservation system may be altered as a result, such as, e.g., a slight price increase for the next price estimate for the user, or a reduction in “earnings points” or other metrics which may be present in the reservation system. In some embodiments, the user may be rewarded in the system by cancelling early enough to meet a threshold time prior to traveling through the highway sections.

FIG. 2B is a flow chart illustrating additional steps that may be performed in accordance with some embodiments. The flow chart shows an example of a process for monitoring the vehicle after a reservation has been made and generating route usage data, along with determining a future price estimate.

At optional step 214, after a reservation has been made by the user, the system monitors the travel of the vehicle along the optimal route. In some embodiments, the monitoring occurs via the client device of the user. In some embodiments, the client device may have, e.g., one or more locational sensors, GPS or other location capabilities, or other means of locating and continuously monitoring the location of the user based on the client device. In some embodiments, the system detects based on this monitoring whether the user is in a vehicle traveling at a certain speed, is outside of a vehicle on foot, or similar. In some embodiments, the system can also detect which speed the user is traveling at, in which direction, at which velocity, and other metrics. As one example, the system may monitor in such a way that it can detect, based on slowing down and/or stopping of the vehicle, that there's an extra stoplight encountered by the vehicle, or other situation which may impact the estimated time of the optimal route. The system can receive a clear idea of users entering highways, user about to enter highways, users exiting highways, users taking different routes than the optimal route provided, and more.

At optional step 216, the system receives route usage data based on the monitoring of the travel. In some embodiments, the route usage data relates to traffic and other conditions with respect to the roadways along the optimal route of the user, including reserved sections of highway and reserved lanes of highway. The route usage data relates to conditions and data generated or received based on the monitoring of the specific user traveling along the route. Conditions may include, e.g., weather conditions, detected traffic accidents, traffic congestion along given roadways, average speed of roadways, quantity of vehicles on the roadway, throughput, lane capacity, and any other suitable condition. In some embodiments, the route usage data is captured or stored within a database such as a route usage repository.

At optional step 218, the system generates aggregate route usage data based on the received route usage data and additional route usage data from additional client devices. The system may aggregate the individual route usage data for individual users and pool them into aggregate route usage data. This includes the specific individual's route usage data, and additional route usage data from other users based on monitoring and tracking of their device's locational data and other data.

At optional step 220, the system determines a future price estimate for reserving the highway sections based at least in part on the aggregate route usage data. The aggregate route usage data may be used as a basis for determining future price estimates for reservations, as it can be an indicator of what the price estimate should be for users who are about to, but haven't initiated the reservation process yet. In some embodiments the future price estimates can factor in traffic conditions, unexpected circumstances on the road such as accidents, weather conditions, and more. The time spent traveling to optimal routes may be modified based on the aggregate route usage data, and the determination of optimal routes may be modified as well. In some embodiments, predictive models can use the aggregate route usage data to better determine what price estimates will be at a given time of day, day of week, month, etc. In some embodiments, the aggregate route usage data may be combined with other factors, such as commuter driving history which has been recorded over time, driving patterns, and other suitable factors. In some embodiments, future traffic conditions can be predicted based on the aggregate route usage data, and future price estimates can be determined for future reservations based on the predicted future traffic conditions.

### IV. Examples

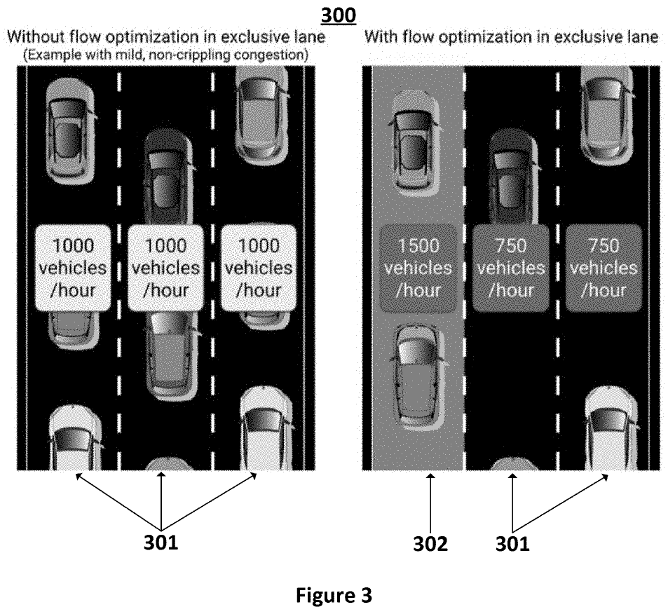

FIG. 3 is a diagram illustrating a comparison 300 of roadway capacity in examples of a roadway without a reserved lane of highway and a roadway with a reserved lane of highway. In the first image on the left, a roadway is depicted without flow optimization, wherein all lanes are general purpose lanes 301. Each of the lanes has an actual roadway throughput (i.e., the amount of cars which are traveling along each lane) of 1,000 vehicles per hour. This leads to all lanes being backed up and congested. In a near-empty highway, for example, speed is high but throughput is low. As traffic builds, throughput increases while speed does not suffer. At a tipping point, however, there is a critical threshold wherein traffic flow becomes unstable and, e.g., a single driver braking can trigger a chain reaction which leads to all drivers being stuck in a gridlock which, in some cases, can persist for hours. If that threshold were not met, the throughput capacity would have been far greater, which each vehicle traveling several times faster. The result is a waste of roadway capacity, not just the individual occupants' time. Thus, the 1,000 vehicles per hour traveling along each line are traveling in “start and stop” conditions, moving very slowly.

The image on the right depicts a roadway with flow optimization via a reservable priority lane 302. Roadway throughput for the priority lane is now 1,500 vehicles per hour, while the general purpose lanes 301 each have a roadway throughput of 750 vehicles per hour. The throughput capacity of each lane increases dramatically, and the speed of each vehicle increase dramatically as well. First, the exclusive lane carries more vehicles than any of the other lanes, which improves traffic congestion. Both drivers using the exclusive lane and not using the exclusive lane benefit from reduced traffic congestion. In addition, the number of options for each driver increases: the use of non-exclusive lanes at the cost of likely congestion; the use of exclusive lanes as carpooling or ride-sharing; and the use of exclusive lanes as a single driver. The system, meanwhile, determines pricing of the reserved lane based on supply (i.e., availability of the reserved lane, based on factors such as throughput capacity) and demand (i.e., number of users requesting reservations for the lane at a given moment in time). The system retains control of vehicle access into the exclusive lane. Therefore, demand is stacked against the fixed supply of road space at any given moment of time, and a clearing price is set based on the market, resulting in less traffic congestion for all lanes. In this way, the market regulates demand through pricing, effectively eliminating peak hours in the priority lane. With traffic adaptation, achieving optimal flow in one or more lanes is equivalent to a capacity increase on the roadway.

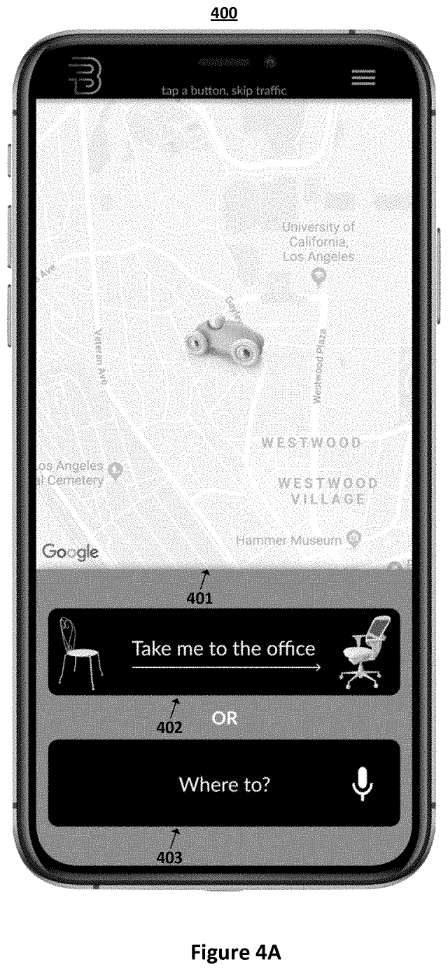

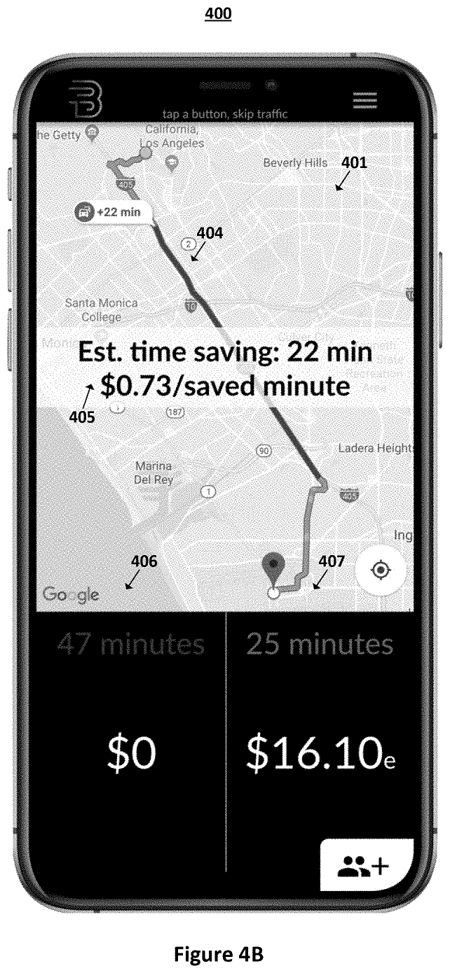

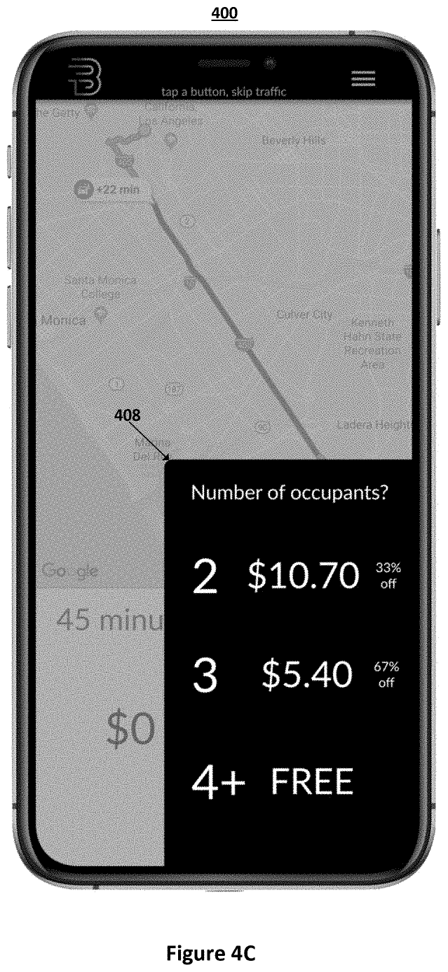

FIGS. 4A, 4B, and 4C depict a user application (i.e., reservation application on a client device) for reserving highway sections and/or reservable lanes of highway sections.

FIG. 4A depicts a destination selection screen of the user application. A user can type or speak a destination (e.g., an address or proper name), or select one of a number of pre-configured destinations (e.g., “Office” or “Home”).

FIG. 4B depicts a quote screen of the user application. The user application can generate and present a price estimate (“quote”) on the quote screen. The quote can include a cost per minute saved by the user by using the priority lane, an estimate of the number of minutes the user may save, and an estimate of the total resulting fee. The user application can estimate the number of minutes that the user may save based on data about other vehicles on the roadway. Such data can be obtained from license plate reading devices on the roadway. The quote screen can also enable the user to accept the quote.

FIG. 4C depicts an occupant quantity selection screen of the user application. This screen may enable a user to select the number of occupants in his or her vehicle, which may result in a discount to use the priority lane.

### Vehicle Occupancy Verification

### I. Background

The vehicle occupancy verification aspect of the present invention addresses shortcomings of the current state of the art. Occupancy verification is the tolling industry's response to some major challenges in tolled highways and toll lanes. The first challenge is the inherent equity issue of using a market mechanism, i.e., price, to regulate highway demand, which can prevent people lacking financial means from using tolled highways or toll lanes and thus accruing the benefits of a faster and more reliable trip. By allowing price discounts or even free travel if enough occupants are inside the vehicle, people are allowed to self-select, i.e., those with lower opportunity costs have a higher incentive to coordinate with others to, for example, commute together. The second challenge is increasing person throughput on a highway, a critical metric for roadside infrastructure. Carpooling vehicles, buses, and other vehicles that carry multiple passengers increase the number of people able to travel on a highway without necessarily increasing the number of vehicles. Absent something akin to occupancy verification, the most traffic management can aspire to is maximizing vehicle throughput. However, it is difficult to ascertain the number of people in a given vehicle.

Current solutions do not deal with this issue in a satisfactory way. Highway patrol officers may attempt to assess the number of people in vehicles, but stopping cars creates congestion, is unsafe, and is hard to monitor manually. Cameras on overhead gantries, which attempt to count the number of occupants by looking through the vehicle windshield, often have trouble assessing the correct headcount, as it is often difficult for them to distinguish a precise number of occupants, and children and infants are often missed. In addition, there are significant privacy concerns. There are smartphone solutions for counting the number of people, but they require each occupant to have a smartphone, which is a difficult requirement to meet and increases friction for users. There may also be switchable transponders in the car which allow a driver to select the number of occupants in the car, but the violation rate is high and users often forget to switch to the right transponder occupancy setting.

In addition, fraud and lying about the number of occupants is a common issue with vehicle occupancy verification. The current techniques are prone to various forms of gaming or cheating on the part of vehicle drivers and occupants.

Thus, there is a need for a solution to verify the number of occupants in a vehicle which overcomes these issues and shortcomings.

### II. Summary

The present solution for vehicle occupancy verification includes a client device, such as a smartphone or similar device, which can account for all of the occupants in the vehicle. When a user wishes to, for example, reserve a highway or lane while receiving price discounts or travel for free, the user can initiate a vehicle occupancy verification process.

An occupancy verification claim is then sent from the client device to a processing unit. In some embodiments, the system receives, from the client device, the occupancy verification claim for the vehicle. In some embodiments, the system may ask the user and the occupants in the vehicle to perform one or more verification actions. The system then obtains verification media from the client device, wherein the verification media is generated based on the verification action. The verification media is then processed to determine a quantity of occupants in the vehicle.

In some embodiments, the verification action includes each of the vehicle occupants reciting a phrase, and the verification media is a recording of the occupants reciting the phrase. In some embodiments, the phrase is a randomly selected phrase from a predefined list of phrases. In some embodiments, the request to perform the verification action includes a request for each of the plurality of occupants to recite the phrase simultaneously. In some embodiments, the request to perform the verification action includes a request for each of the plurality of occupants to recite the phrase one after another. In some embodiments, processing the verification media to determine the quantity of the occupants in the vehicle includes analyzing acoustic features of the recitation of the phrase. In some embodiments, processing the verification media to determine the quantity of the occupants in the vehicle includes disambiguating different speakers reciting the phrase into separate and distinct speakers.

In some embodiments, the verification action includes a request for at least one occupant of the vehicle to capture and send, via the client device, one or more pieces of visual media of the interior of the vehicle with all of the occupants appearing in the one or more pieces of visual media, wherein the verification media is the one or more pieces of visual media. In some embodiments, the visual media may be, e.g., images, video, or a combination of images and video. In some embodiments, the processing of the verification media includes processing the one or more images using an object detection algorithm implemented on the client device. In some embodiments, the object detection algorithm is an artificial intelligence algorithm. In some embodiments, the verification action further includes performing one or more gestures in order to prevent gaming or cheating of the occupancy verification.

In some embodiments, a probability is determined for the request to perform the verification action to be sent to the client device. The request to perform the action is only sent based on the probability. This probability can be determined in a number of ways. In some embodiments, the probability is determined based on the verification fraud rate within a given population associated with a location of the vehicle. In some embodiments, the probability is determined based on a history of verification fraud in past verification attempts associated with a user of the client device.

In some embodiments, the occupancy verification claim includes a stated number of occupants in the vehicle. In some embodiments, the system receives user preferences for verification actions, and the request to perform a verification action is based on the user preferences. In some embodiments, the verification media includes partial or full manual determination of the quantity of the occupants in the vehicle. In some embodiments, determining a price estimate for the reservation is based at least in part on the determination of the quantity of occupants in the vehicle.

The features and components of these embodiments will be described in further detail in the description which follows. Additional features and advantages will also be set forth in the description which follows, and in part will be implicit from the description, or may be learned by the practice of the embodiments.

### III. Example Embodiments

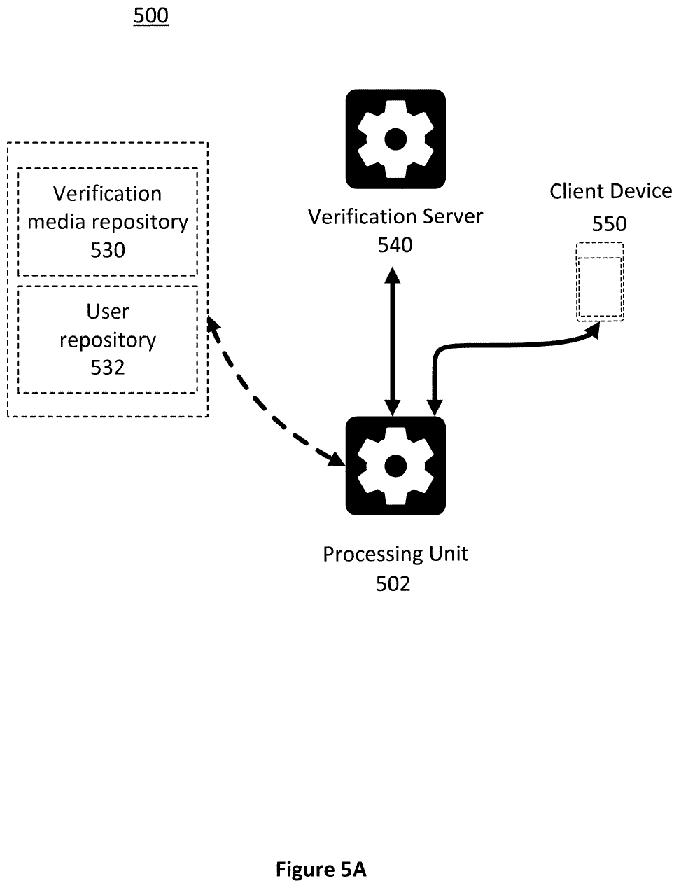

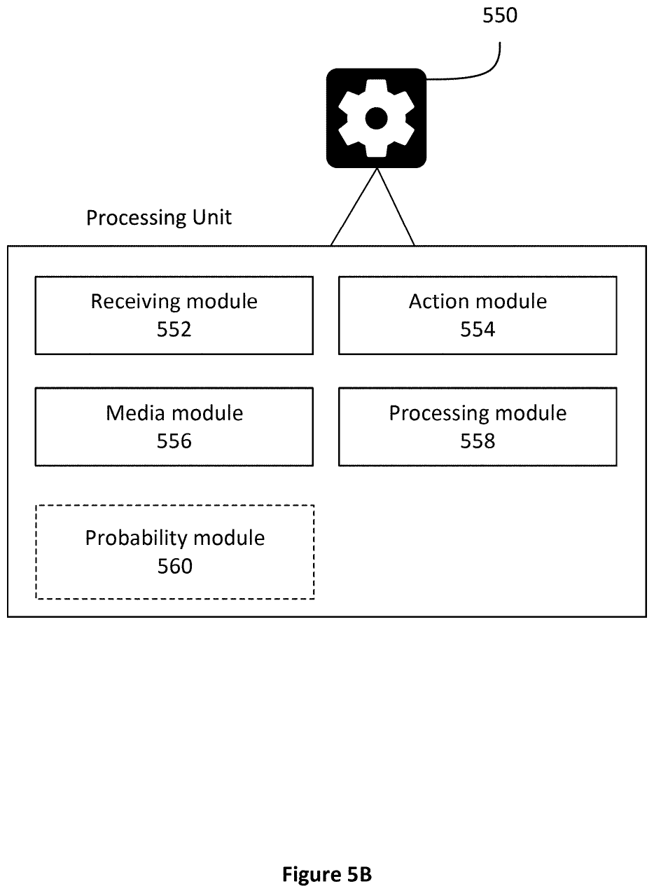

FIG. 5A is a diagram illustrating an exemplary environment in which some embodiments may operate. In the exemplary environment 500, a client device 550 is connected to a processing unit 502. The processing unit 502 is optionally connected to one or more optional database(s), including a verification media repository 530 and/or user repository 532. One or more of the databases may be combined or split into multiple databases. The processing unit 502 is connected to a pricing server 540. The pricing server 540 and/or client device 550 in this environment may be computers.

The exemplary environment 500 is illustrated with only one client device and processing unit for simplicity, though in practice there may be more or fewer client devices and/or processing units. In some embodiments, the client device and processing unit may be part of the same computer or device.

In an embodiment, the processing unit 502 may perform the method 200 or other method herein and, as a result, provide for a vehicle occupancy verification system. In some embodiments, this may be accomplished via communication with the client device, pricing server 540, and/or other device(s) over a network between the client device 550, pricing server 540, and/or other device(s), application server(s) or other network server(s). In some embodiments, the processing unit 502 is an application hosted on a computer or similar device, or is itself a computer or similar device configured to host an application to perform some of the methods and embodiments herein.

Client device 550 is a device that sends and receives information to the processing unit 502. In some embodiments, client device 550 is a computing device capable of hosting and executing one or more applications or other programs capable of sending and receiving information. In some embodiments, the client device 550 may be a mobile device (such as, e.g., a smart phone or tablet), computer desktop or laptop, on-board vehicle computer (such as, e.g., a smart vehicle), virtual reality or augmented reality device, wearable, or any other suitable device capable of sending and receiving information. In some embodiments, the processing unit 502 may be hosted in whole or in part as an application executed on the client device 550. In some embodiments, client device 550 may have one or more cameras for image and/or video, and/or one or more microphones for audio.

Pricing server 540 refers to a server in which at least a portion of the processing of the methods described are performed. In varying embodiments, the pricing server 540 can connect and/or authenticate a user within the verification system, provide user history, or a number of other aspects of the methods described. In some embodiments, the pricing server 540 is a remote server which the client device 550 and/or processing unit 502 connect to.

Optional database(s) include one or more of a verification media repository 530 and/or a user repository 530. These optional databases function to store and/or maintain, respectively, verification media (such as images, videos, or audio) user data, or other suitable media or data. Other optional database(s) may be contemplated for other pieces of data throughout the system. In some embodiments, the optional database(s) can be queried by one or more components of system 500 (e.g., by the processing unit 502), and specific stored data in the database(s) can be retrieved.

FIG. 5B is a diagram illustrating an exemplary computer system that may execute instructions to perform some of the methods therein. The diagram shows an example of a processing unit configured to provide a vehicle occupancy verification system. Processing unit 550 may be an example of, or include aspects of, the corresponding element or elements described with reference to FIG. 5A. In some embodiments, processing unit 550 is a component or system on an enterprise server. In other embodiments, processing unit 550 may be a component or system on client device 520, or may be a component or system on peripherals or third-party devices. Processing unit 550 may comprise hardware or software or both.

In the example embodiment, processing unit 550 includes receiving module 552, action module 554, media module 556, processing module 558, and optional probability module 560.

Receiving module 552 functions to receive data from the client device, pricing server, and/or other devices or computing systems via a network. The data received can include, e.g., occupancy verification claims and verification media. In some embodiments, the network may enable transmitting and receiving data from the Internet. Data received by the network may be used by the other modules. The modules may transmit data through the network.

Action module 554 functions to request and facilitate performance of verification actions, as will be described in further detail below.

Media module 556 functions to obtain verification media, as will be described in further detail below.

Processing module 558 functions to process verification media to determine a quantity of occupants in the vehicle, as will be described in further detail below.

Optional probability module 560 functions to determine a probability for requesting verification actions, as will be described in further detail below.

### IV. Methods

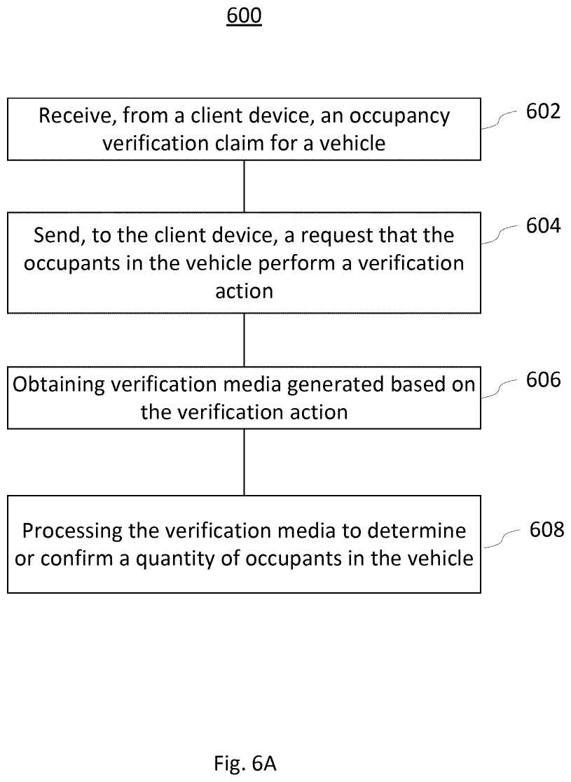

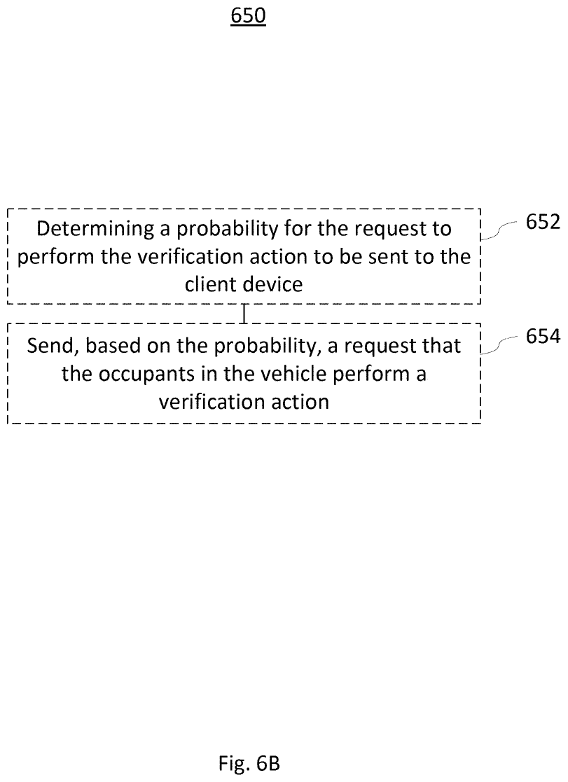

FIG. 6A is a flow chart illustrating an exemplary method that may be performed in accordance with some embodiments. The flow chart shows an example of a process for determining the number of occupants in a vehicle. In some examples, these operations may be performed by a system including a processor executing a set of codes to control functional elements of an apparatus. Additionally or alternatively, the processes may be performed using special-purpose hardware. Generally, these operations may be performed in accordance with some aspects of the systems and methods herein. For example, the operations may be composed of various substeps, or may be performed in conjunction with other operations described herein.

At step 602, the system receives, on a client device associated with a user, an occupancy verification claim for a vehicle. In some embodiments, the client device is running an application (“app”) which presents a user interface for a vehicle occupancy verification system. In some embodiments, the verification system is a portion of a larger application, e.g., a reservation system. In some embodiments, the verification request may be a prompt on the client device to initiate a vehicle occupancy verification process, or a prompt to enter or speak a number of occupants present in the vehicle. At that point, the user can opt to grant initiation of the process, claim the number of occupants in the vehicle, or otherwise respond.

At step 604, the system sends, to the client device, a request that the occupants in the vehicle perform a verification action. In some embodiments, this is performed in response to the client device sending the verification request. In some embodiments, the system may additionally receive one or more user preferences related to verification actions, such as preferred actions or actions which occupants should not be asked, and a verification action may be performed based on the user preferences.

In some embodiments, the verification action may involve the vehicle occupants being asked via a prompt to recite a phrase. The phrase may be a randomly selected phrase, in order to circumvent any potential fraud attempts. For example, if a user attempts to use a prerecorded sound bite, the system may randomly select a phrase from a predefined list of phrases, and the prerecorded sound bite is unlikely to be a response to that sound bite. In some embodiments, the occupants are asked to recite the phrase simultaneously, while in other embodiments, the occupants are asked to recite the phrase one after another.

In some embodiments, the verification action may involve at least one of the vehicle occupants being asked to capture and send one or more pieces of visual media of the interior of the vehicle with all of the occupants appearing in the one or more pieces of visual media. In some embodiments the visual media may be images, video, or a combination of images and video. In some embodiments, the occupants may be further asked to perform one or more gestures while the capturing of the media is being performed.

At step 606, the system obtains verification media generated based on the verification action. In varying embodiments, the verification media may be, e.g., audio recorded by one or more occupants, visual media (e.g., images and/or video), or any other suitable form of media generated by the verification action.

At step 608, the system processes the verification media to determine a quantity of occupants in the vehicle. In some embodiments involving audio recordings, the processing may include analyzing acoustic features of the recitation of the phrase, and/or disambiguating the voices of different speakers reciting the phrase, such that the speakers are classified as separate and distinct speakers. In some embodiments involving visual media, the processing may include using an object detection algorithm implemented on the client device and/or pricing server. The object detection algorithm may be, in some embodiments, an artificial intelligence (“AI”) algorithm, such as a machine learning (“ML”) algorithm, computer vision algorithm, or other suitable AI algorithm.

In some embodiments, processing the verification media may involve partial or full review on a manual basis by one or more human verifiers. Such human verifiers may watch the video or images or listen to the audio recordings, and may independently and manually determine the number of occupants in the video based on the verification media. In some cases, human verifiers may be able to count the number of occupants in a way that algorithms are unable to.

In some embodiments, after determining the number of occupants in the vehicle, the system can determine a price estimate for a reservation based at least in part on the determination of the number of occupants in the vehicle. Determine price estimates for reservations is described in further detail throughout.

FIG. 6B is a flow chart illustrating additional steps 650 that may be performed in accordance with some embodiments. The flow chart shows an example of a process for determining a probability for whether the verification action request is sent to the user, then sending the request based on the probability.

At optional step 652, the system determines a probability for the request to perform the verification action to be sent to the client device. In some embodiments, the system may only ask occupants to verify the number on some occasions, based on a probability. This probability may be between 0% to 100% or any smaller range depending on various embodiments. In some cases, the system is designed to lower friction or difficulty for occupants to take advantage of, e.g., a reservation system or other system. Forcing occupants to perform a headcount or verification actions every time a reservation is made may lead to frustration and/or lower adoption of the service. Thus, in varying embodiments, probability for whether occupants are asked to verify can depend on a variety of factors. In some embodiments, an estimate of a verification fraud (i.e., cheating or gaming the system to lead to a determination of a false number of occupants in the vehicle) within the population is made based on aggregate verification fraud data from users of the system. Populations may be, e.g., a population of a specific city, county, area, state, country, or other population. Probabilities of being asked to verify may then increase based on if the population that attempts to cheat the system is higher with respect to other populations. In other embodiments, probability may increase if the particular user associated with the user account or client device has a history of attempted or suspected fraud verification in past verification attempts. In some cases, a user may never be asked to verify (i.e., 0% probability), while in other cases, a user may be asked to verify every single time (i.e., 100% probability).

At step 654, the system sends, based on the probability, a request that the occupants in the vehicle perform a verification action. This step is the same as step 604 as discussed in FIG. 6A, but the probability is a factor into whether the request is sent or not.

### IV. Examples

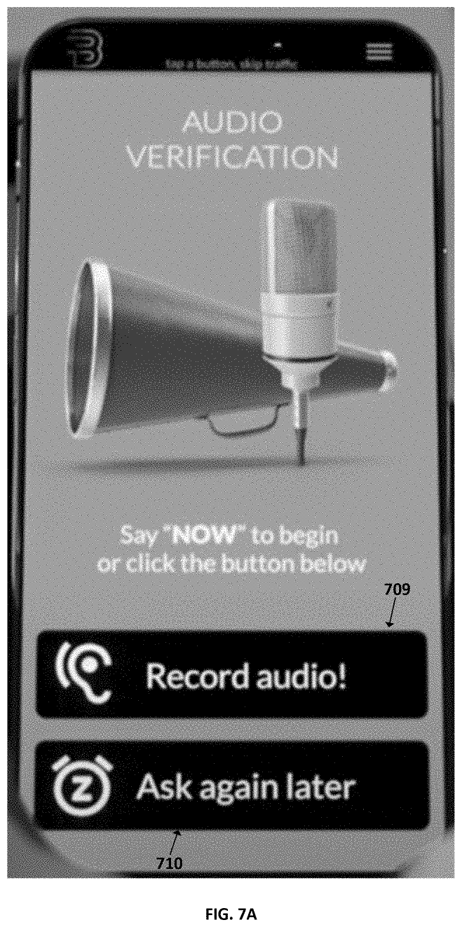

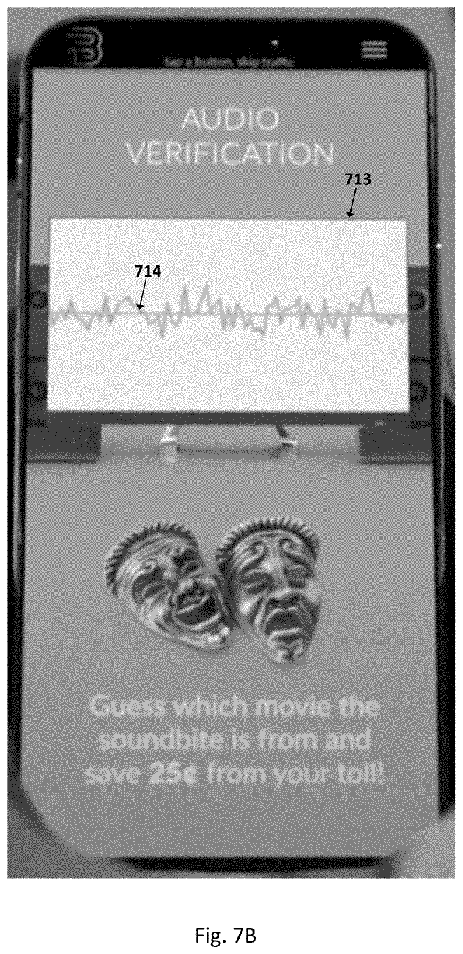

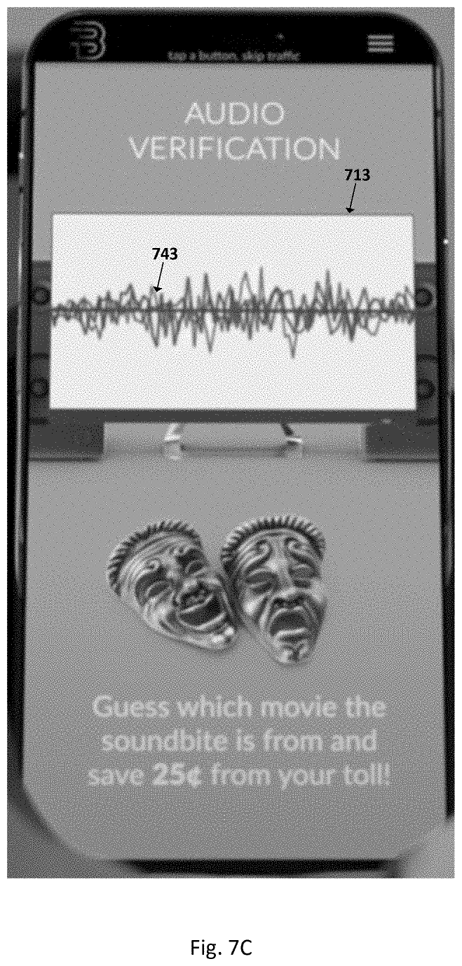

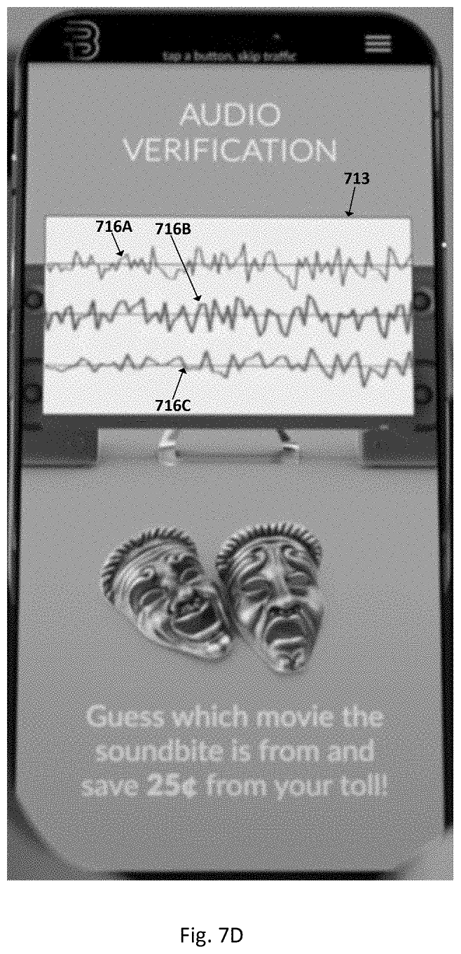

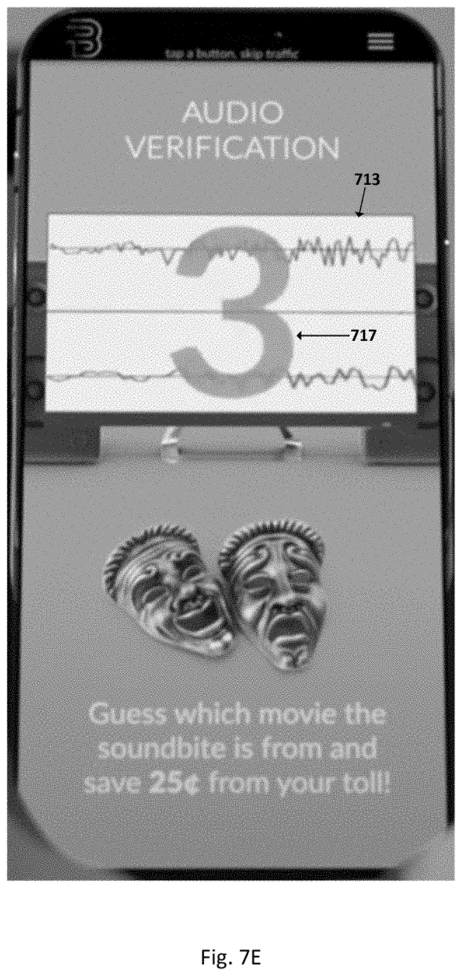

FIGS. 7A-7E show an example audio verification interface 710 in accordance with aspects of the present disclosure.

In FIG. 7A, the user may be prompted to verify the selected number of passengers. The user may speak a trigger phrase, such as “NOW,” or select recording button 709 to begin the verification process. A phrase or word, to be repeated by the one or more passengers, may be played by the device's speakers or written in text on the screen. The verification word or phrase may be randomly generated, randomly selected from movies/TV/song lyrics, or from a database of predetermined phrases. The one or more users may then repeat/speak the phrase at the same time, or within a threshold window of time. The user may also choose to select the snooze button 710 to be prompted at a later time to complete the occupancy verification process.

In FIG. 7B, the device may record the passengers audibly repeating/speaking the verification phrase. The waveform window 713 may display, in real-time, a representative waveform of the user's voice as the phrase is being spoken. If there is only one passenger, a single passenger waveform 714 may be displayed.

FIG. 7C shows an example of three passengers speaking the verification phrase. After the passengers are prompted to repeat the verification phrase, the system may record the audio from within the vehicle and display the multi-passenger combined waveform 743 in the waveform window 713. In FIGS. 7D and 7E, the multi-passenger combined waveform 743 may be filtered and processed, so as to isolate individual passenger voices from the recording. The multi-passenger isolated waveforms 716A-716C may be displayed individually or separately in the waveform window 713. The number of identified voices may be displayed as a verified voice count 717, and the verified voice count 717 may then be compared against the number of passengers previously selected.

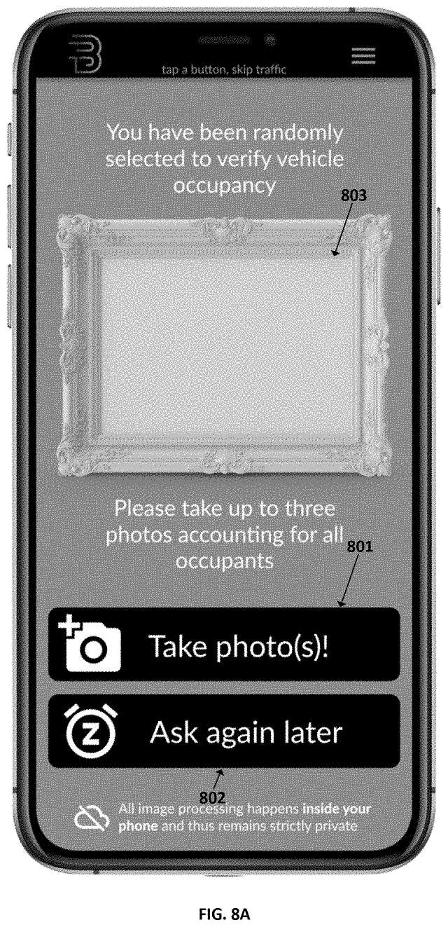

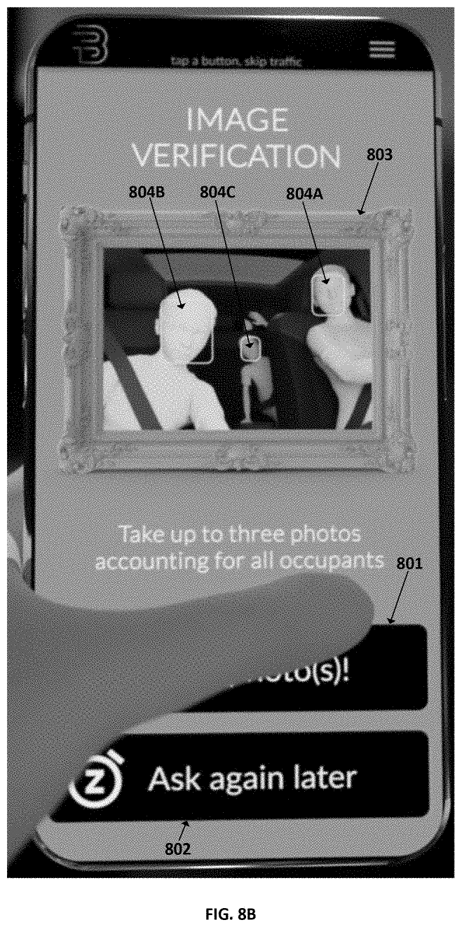

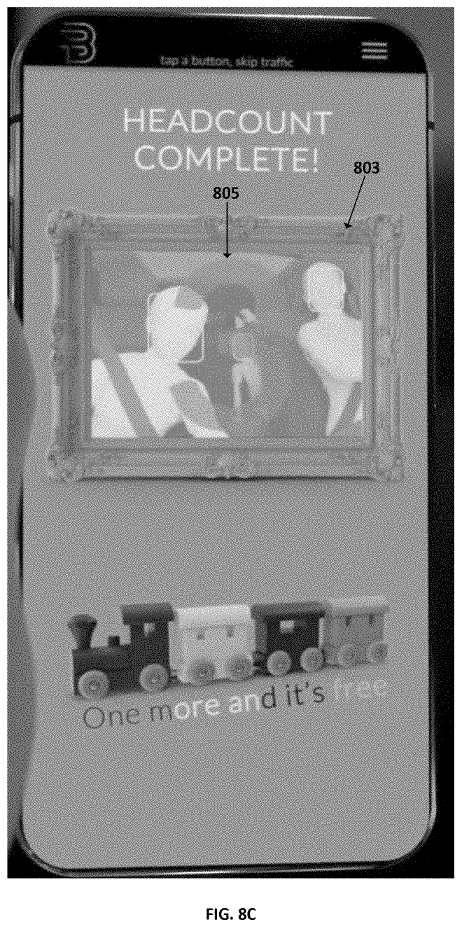

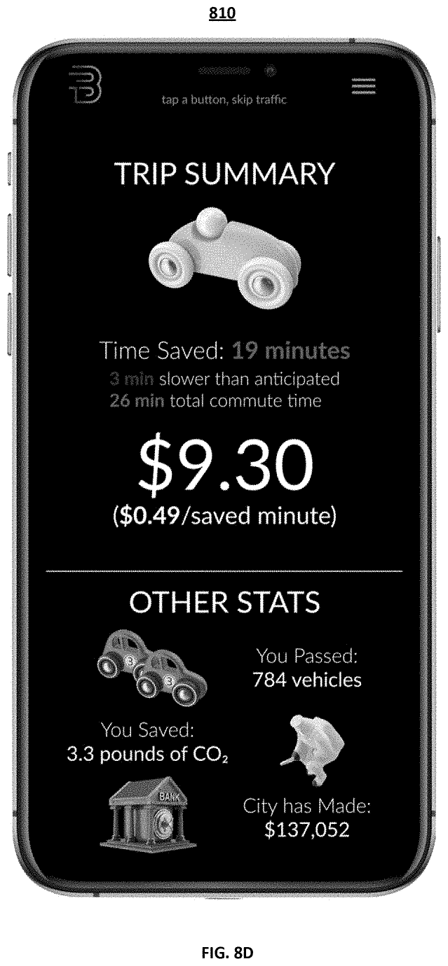

FIG. 8A-C shows an example image verification interface 800 in accordance with aspects of the present disclosure. Image verification interface 800 may comprise an image capture button 801, an image snooze button 802, an image preview window 803, one or more recognized passenger indicators 804A-804C and a verified image count 805.

In FIG. 8A, the user may be prompted to verify the selected number of passengers. The user may be prompted to capture one or more images or videos which show the one or more passengers within the vehicle. The user may view the current image frame in the image preview window 803 before capturing the one or more images or videos. The user may touch, tap, or otherwise select the image capture button 801 to store the image and begin facial recognition, object identification, or other computer vision processes. A long press on the image capture button 801 may result in a video or a burst of pictures (multiple pictures on a single press) being taken for the purpose of verification. Multiple images or multiple frames from a video may be used to determine depth of the detected passengers. Monocular depth estimation as well as structure from motion and other depth estimation techniques may be used to determine the depth of the passengers. In some embodiments, a depth determination may not be necessary, and a single still frame image may be used for passenger identification and verification. FIG. 8B shows an example of a user verifying the number of passengers in the vehicle. Image preview window 803 shows the view from the device's camera. Passenger indicators 804A-804C are shown over the recognized passenger faces. Upon detecting all of the passengers, the verified image count 805 may then be compared against the number of passengers previously selected.

Regarding FIG. 8D, after completion of the trip, a trip summary 810 page may be displayed to the user. Trip summary 810 may show time saved, total time, difference between estimated commute and actual commute times, cost of the commute, savings per minute, as well as other statistics related to the commute. These additional statistics may include environmental impact information about the commute, such as pounds of carbon dioxide saved, or general commute information, such as number of cars passed.

### Dynamic Determination of a Highway Toll Price

### I. Background

Dynamic determination of highway tolling prices and highway reservation prices is superior to static, fixed prices for a number of reasons, such as improving congestion management by dissuading new traffic through increasing prices based on current road conditions. Highway toll facilities throughout the world take a variety of approaches to dynamic pricing of tolls. In some cases, prices are dynamically set for an entire highway or highway section so as to avoid congestion on that highway or highway section. This is an attempt at calibrating the vehicle throughput algorithms behind the traffic management of highways. As a result, the goal is for vehicles on the highway to experience reduced congestion and increased speed.

While this may work to reduce congestion, no toll facility is dynamically charging toll fees based on whether specific drivers are saving time or not, which is the attribute that drivers find most relevant to their needs. A direct correlation between payment and saved time is a dynamic that drivers can directly use to make decisions on paying tolls or not and driving along certain sections of highway or not. Thus, there is a need for new systems and methods directed to dynamic determination of highway toll prices based on amount of time saved.

### II. Summary

The systems and methods described herein provide for dynamic determination of highway toll prices based on amount of time saved. In one embodiment, the system receives, from a client device associated with a user, a travel destination and a user location, then determines an optimal route to the destination from the user location. Next, the system calculates an estimated time for the user in a vehicle to travel along the optimal route to the destination by using highway sections that are reservable, then determines, based on this estimated time, an estimated time saved by using the highway sections that are reservable. The system then determines an initial price estimate based at least in part on the estimated time saved. The system tracks the speed of the vehicle traveling along the optimal route and the speed of a plurality of additional vehicles traveling along highway sections that are not reservable, calculates an effective time saved based on the tracked speed of the vehicle and the tracked speed of the additional vehicles, and adjusts the price estimate based on the effective time saved.

In some embodiments, the speed of the plurality of additional vehicles is tracked via one or more overhead tolling gantries, cameras along the route, speed detection devices, license plate recognition devices, and/or road data aggregation services. In some embodiments, the speed of the additional vehicles is tracked via additional client devices associated with users of the additional vehicles, wherein the additional client devices are capable of transmitting speed and locational data. In some embodiments, the speed of the vehicle traveling along the optimal route is tracked via the client device, wherein the client device is capable of transmitting speed and locational data. In some embodiments, determining the estimated time saved is based at least in part on comparing the estimated time to be spent to previous time data of users traveling along highway sections that are not reservable.

In some embodiments, the highway sections that are reservable include one or more priority lanes of a highway and the highway sections that are not reservable include one or more general purpose lanes of a highway. In some embodiments, the effective time saved is calculated upon the vehicle exiting the last highway section that was reserved. In some embodiments, the effective time saved is calculated upon the vehicle reaching the travel destination. In some embodiments, the initial price estimate is adjusted only if the price is to be adjusted downward based on the effective time saved.

In some embodiments, the system monitors the location of the vehicle traveling along the optimal route to detect that the vehicle is remaining on the optimal route. In some embodiments, the system processes a payment based on the adjusted price estimate. In some embodiments, the client device contains one or more locational sensors.

The features and components of this and other embodiments will be described in further detail in the description which follows. Additional features and advantages will also be set forth in the description which follows, and in part will be implicit from the description, or may be learned by the practice of the embodiments.

### III. Exemplary Embodiments

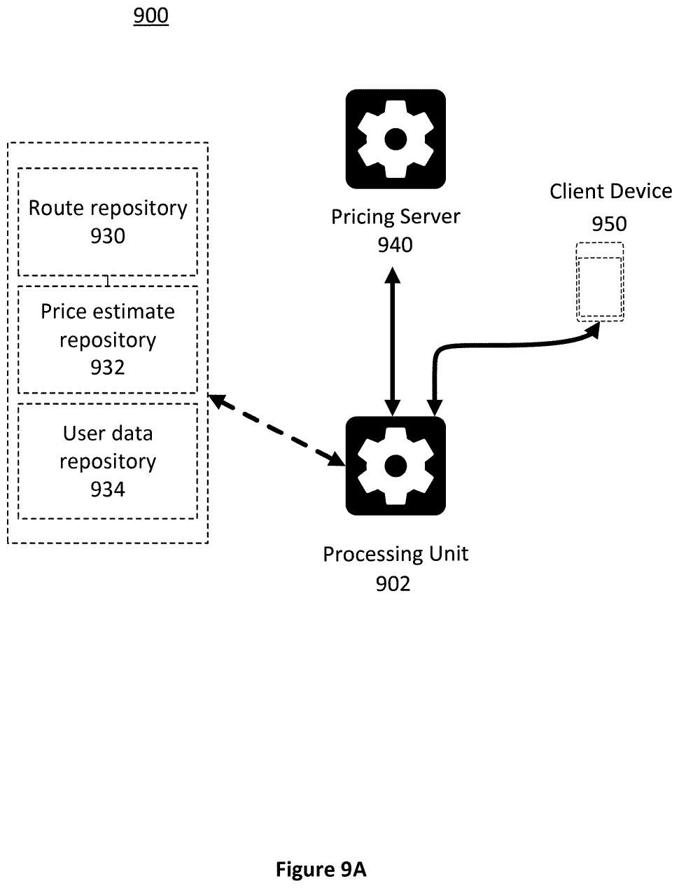

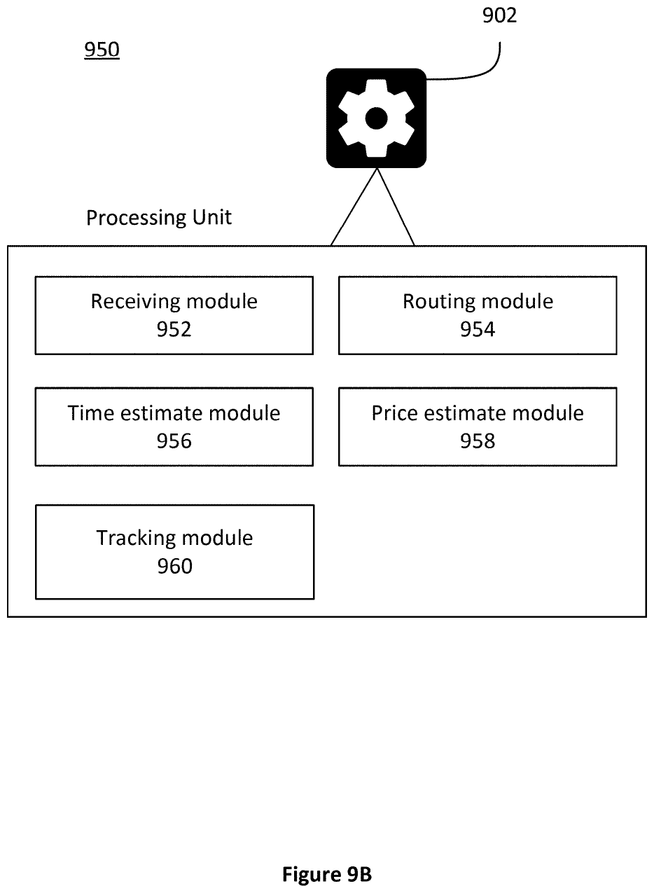

FIG. 9A is a diagram illustrating an exemplary environment in which some embodiments may operate. In the exemplary environment 900, a client device 950 is connected to a processing unit 902. The processing unit 902 is optionally connected to one or more optional database(s), including a route repository 930, price estimate repository 932, and/or user data repository 934. One or more of the databases may be combined or split into multiple databases. The processing unit 902 is connected to a pricing server 940. The pricing server 940 and/or client device 950 in this environment may be computers.

The exemplary environment 900 is illustrated with only one client device and processing unit for simplicity, though in practice there may be more or fewer client devices and/or processing units. In some embodiments, the client device and processing unit may be part of the same computer or device.

In an embodiment, the processing unit 902 may perform the method 200 or other method herein and, as a result, provide for dynamic toll pricing system. In some embodiments, this may be accomplished via communication with the client device, pricing server 940, and/or other device(s) over a network between the client device 950, pricing server 940, and/or other device(s), application server(s) or other network server(s). In some embodiments, the processing unit 902 is an application hosted on a computer or similar device, or is itself a computer or similar device configured to host an application to perform some of the methods and embodiments herein.

Client device 950 is a device that sends and receives information to the processing unit 902. In some embodiments, client device 950 is a computing device capable of hosting and executing one or more applications or other programs capable of sending and receiving information. In some embodiments, the client device 950 may be a mobile device (such as, e.g., a smart phone or tablet), computer desktop or laptop, on-board vehicle computer (such as, e.g., a smart vehicle), virtual reality or augmented reality device, wearable, or any other suitable device capable of sending and receiving information. In some embodiments, the processing unit 902 may be hosted in whole or in part as an application executed on the client device 950. In some embodiments, client device 950 may have one or more locational sensors or other means of transmitting speed and locational data.

Pricing server 940 refers to a server in which at least a portion of the processing of the methods described are performed. In varying embodiments, the pricing server 940 can connect and/or authenticate a user within the verification system, provide historical time data or price data, or a number of other aspects of the methods described. In some embodiments, the pricing server 940 is a remote server which the client device 950 and/or processing unit 902 connect to.

Optional database(s) include one or more of a route repository 930, price estimate repository 932, and/or a user data repository 934. These optional databases function to store and/or maintain, respectively, route and optimal route data, initial and adjusted price estimates, user data, or other suitable media or data. Other optional database(s) may be contemplated for other pieces of data throughout the system. In some embodiments, the optional database(s) can be queried by one or more components of system 900 (e.g., by the processing unit 902), and specific stored data in the database(s) can be retrieved.

FIG. 9B is a diagram illustrating an exemplary computer system that may execute instructions to perform some of the methods therein. The diagram shows an example of a processing unit configured to provide a dynamic toll pricing system. Processing unit 950 may be an example of, or include aspects of, the corresponding element or elements described with reference to FIG. 9A. In some embodiments, processing unit 950 is a component or system on an enterprise server. In other embodiments, processing unit 950 may be a component or system on client device 920, or may be a component or system on peripherals or third-party devices. Processing unit 950 may comprise hardware or software or both.

In the example embodiment, processing unit 950 includes receiving module 952, routing module 954, time estimate module 956, price estimate module 958, and tracking module 960.

Receiving module 952 functions to receive data from the client device, pricing server, and/or other devices or computing systems via a network. The data received can include, e.g., a travel destination, user location, speed data, or any other suitable data. In some embodiments, the network may enable transmitting and receiving data from the Internet. Data received by the network may be used by the other modules. The modules may transmit data through the network.

Routing module 954 functions to determine an optimal route to the destination from the user location, as will be described in further detail below.

Time estimate module 956 functions to calculating an estimated time for the user in a vehicle to travel along the optimal route to the destination by using highway sections that are reservable, and also functions to determine an estimated time saved based on the calculated estimated time spent, as will be described in further detail below.

Price estimate module 958 functions to determine an initial price estimate as well as adjust the initial price estimate, as will be described in further detail below

Tracking module 958 functions to track the speed of the vehicle traveling along the optimal route and the speed of a plurality of additional vehicles traveling along highway sections that are not reservable, as will be described in further detail below.

### III. Methods

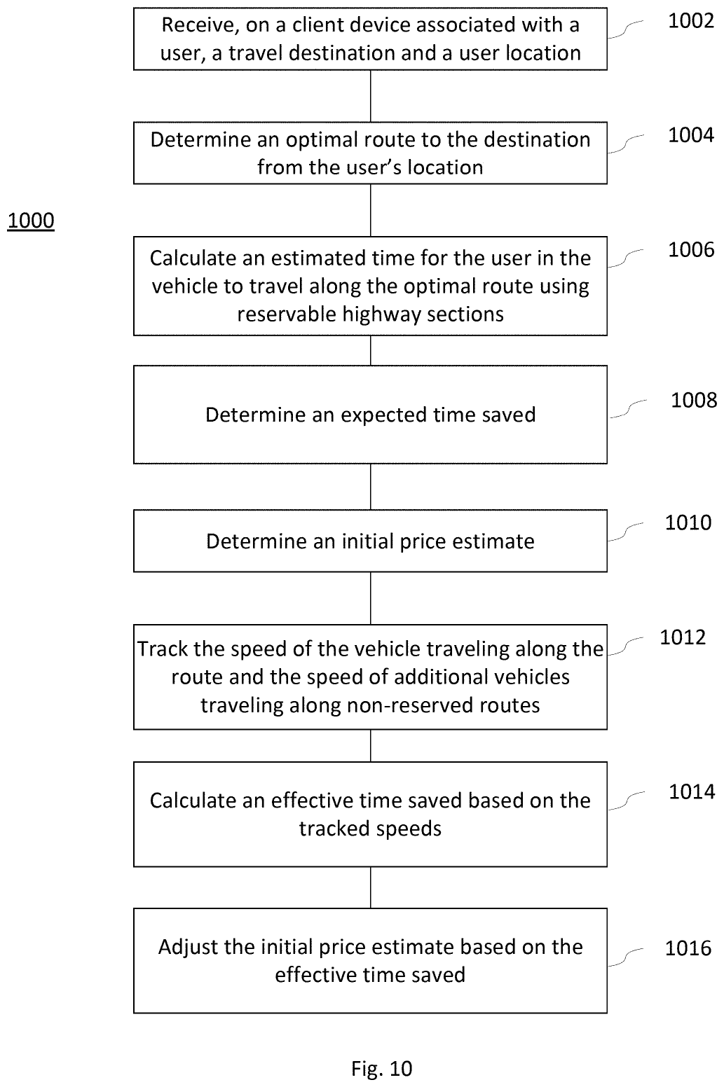

FIG. 10 is a flow chart illustrating an exemplary method that may be performed in accordance with some embodiments. The flow chart shows an example of a process for dynamically determining toll prices. In some examples, these operations may be performed by a system including a processor executing a set of codes to control functional elements of an apparatus. Additionally or alternatively, the processes may be performed using special-purpose hardware. Generally, these operations may be performed in accordance with some aspects of the systems and methods herein. For example, the operations may be composed of various substeps, or may be performed in conjunction with other operations described herein.

At step 1002, the system receives, on a client device associated with a user, a travel destination and a user location. In some embodiments, the client device is running an application which presents a user interface for a dynamic tolling platform, reservation system, or other service. Upon executing the application, the user may be prompted to sign onto the platform as an existing user or register for a new user account. In some embodiments, authentication and verification are performed on the user before connecting the user to the platform. In some embodiments, a connected user is given the option to start a new journey, enter a new destination, or otherwise interact with the application to initiate a reservation.

At step 1004, the system determines an optimal route to the destination from the user's location. In some embodiments, the system connects to a routing or navigating system or application which is capable of determining the optimal route. Such a navigation system may include a map and/or routing service. In some embodiments, the navigation system may be a first-party system, third-party system, and/or open source service, such as, e.g., Google Maps or OpenMaps. In some embodiments, the reservation system interacts with the navigation system via an API or other suitable method. The navigation system outputs a best or optimal route to the destination, based on one or more criteria which may be specified by the system and/or user in varying embodiments.

At step 1006, the system calculates an estimated time for the user in the vehicle to travel along the optimal route using reservable highway sections. In some embodiments, the estimated time may be calculated by the routing or navigation system, or calculating based on historical data from previous trips of the same or similar route by the user or other users of the platform.

In some embodiments, some or all of the reservable highway sections may constitute one or more priority lanes in the highway or section of highway, as opposed to non-priority, general purpose lanes. In some embodiments, reservable highway sections can refer to any tollway or tolling portion of a highway, or any toll lane of a highway.

At step 1008, the system determines an estimated time saved using highway sections that are reservable. The estimated time saved is determined based on the estimated time calculated at step 1006. In some embodiments, the system determines estimated time saved based on comparing the estimated time spent to previous or historical time data of users traveling along highway sections that are not reservable. In some embodiments, the estimated time saved may be determined based on comparing an average speed of users traveling along non-reservable highway sections to an average speed of users traveling along reservable highway sections.

At step 1010, the system determines an initial price estimate based, at least in part, estimated time saved. For example, the initial price estimated may be calculated such that if less time is saved, the price is lower, whereas if more time is saved, the price is higher. In some embodiments, the initial price quote is equivalent to the estimated price per minute saved, or other time-based price, multiplied by the estimated saved time. For example, the initial price estimate can be understood in some embodiments as the number of minutes the system predicts that it will save you using the highway sections multiplied by a price per saved minute. In some embodiments, the user is provided with the initial price estimate and is informed that the price is not a fixed price, but may be adjusted based on additional time saved or other factors. In some embodiments, the user is further informed that the price is the maximum price, at a cap, and that the price can only be adjusted downward, not upward. This is because the system is designed such that the user is not charged a higher price at a later time after agreeing to the price estimate. The user then accepts the price estimate and proceeds along the route in the vehicle.

At step 1012, the system tracks the speed of the vehicle as it travels along the route, and also tracks the speed of additional vehicles traveling along non-reserved routes. The additional vehicles may be, in some embodiments, additional users of the platform who are traveling along the routes, and/or users of one or more third party navigation or road data aggregation services.

In varying embodiments, the speed of the additional vehicles and/or the user vehicles can be tracked via one or more of: overhead tolling gantries, cameras fixed along the route, speed detection devices, license plate recognition devices, and/or road data aggregation services. For example, if a vehicle passes two or more tolling points (i.e., overhead gantries), the speed differential can be tracked and transmitted to the system. This can be used to determine speed immediately after the vehicle passes the overhead gantries. In some embodiments, the gantries have radio frequency identification (“RFID”) equipment which can be linked to a transponder on the vehicle's windshield. In some embodiments, the gantries can be instructed to capture images and/or video of the vehicle's license plate.

In some embodiments, the speed of the additional vehicles is tracked via additional client devices associated with users of the additional vehicles, wherein the additional client devices are capable of transmitting speed and locational data. Thus, for example, a smart phone's built-in GPS capabilities may be able to transmit location and speed (or, e.g., velocity) data to the system. The speed of the user vehicle may be calculated similar based on the user's client device transmitting speed and locational data. In some embodiments, the location of the user's vehicle is additionally monitored to detect that the vehicle is continuing to remain on the optimal route.

At step 1014, the system calculates an effective time saved based on the tracked speeds of the vehicle and the tracked speed of the additional vehicles. In some embodiments, the effective time saved is calculated upon the vehicle exiting the last highway section that was reserved, while in other embodiments, the effective time saved is calculated upon the vehicle reaching the travel destination. In some embodiments, the effective time saved is calculated based on a comparison between the speed of the user vehicle and the speed of the additional vehicles.

At step 1016, the system adjusts the initial price estimate based on the effective time saved. In some embodiments, the price estimate is adjusted only if the price is to be adjusted downward based on the effective (i.e., actual) time saved being less than the estimated time saved. In some embodiments, the initial price estimate is adjusted downward only at the destination, while in other embodiments, the initial price estimate is adjusted downward upon exiting the last highway section that was reserved. In some embodiments, the price is adjusted multiple times throughout the trip, as the system continually tracks the speed of vehicles and recalculates effective time saved.

In some embodiments, once the user reaches the destination, the system initiates processing of a payment based on the adjusted price estimate.

### IV. Examples

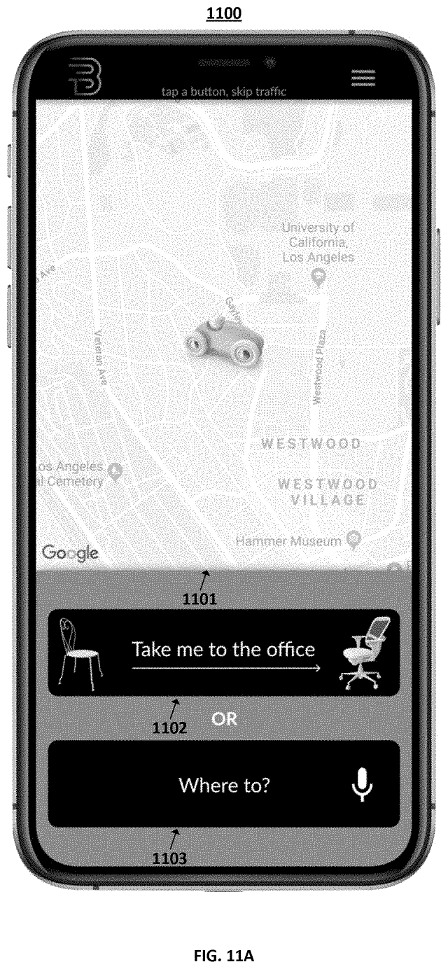

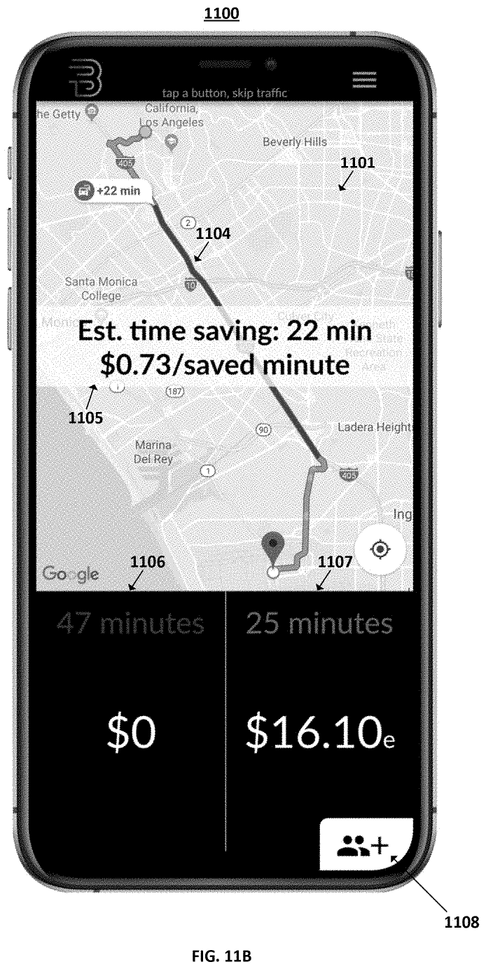

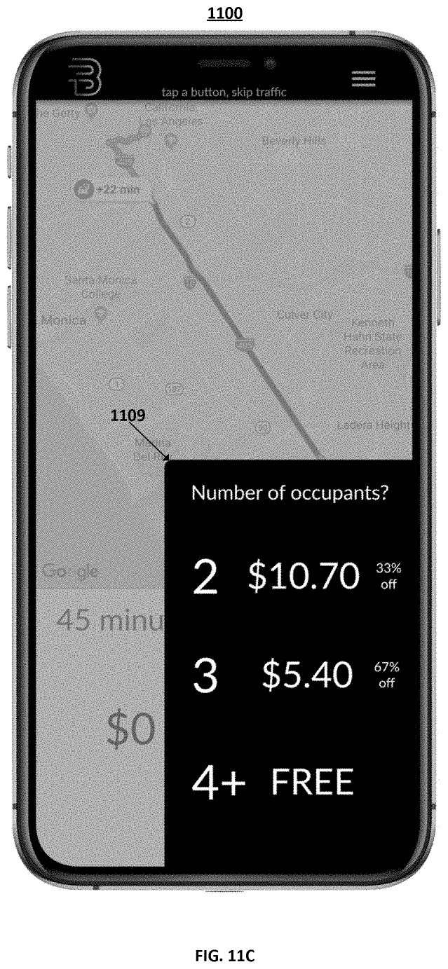

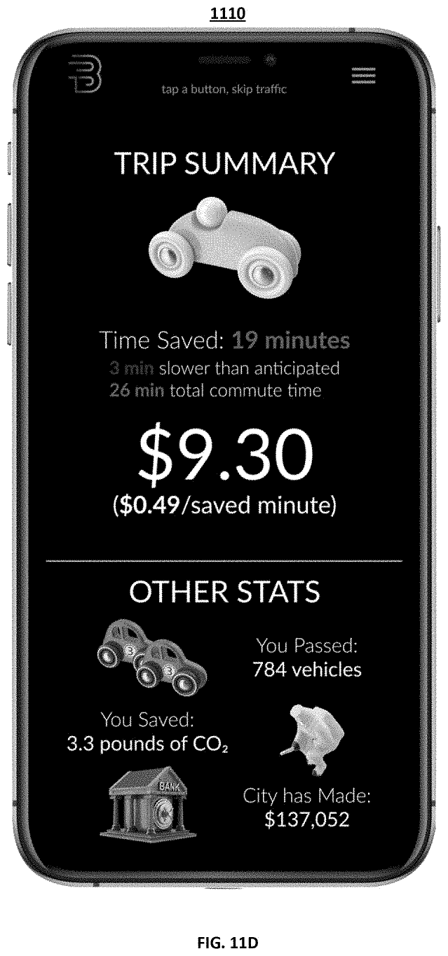

FIGS. 11A-11D show an example interface 1100 of a dynamic price determination platform in accordance with aspects of the present disclosure. Interface 1100 may comprise a map pane 1101, a preset destination selection button 1102, a destination entry button 1103, a planned route 1104, a saved time estimate 1105, free lane travel time 1106, a booked lane travel time 1107, an occupant selection button 1108, an occupant selection pane 1109 and a trip summary 1110.

While operating the interface 1100, the user may be shown a map, in map pane 1101, of the user's current location. The user may touch, tap or otherwise select the preset destination selection button 1102 or the destination entry button 1103. Preset destination selection button 1102 may be a destination that has previously been entered through the destination entry button 1103 by the user during a prior operation of the interface 1100. The preset destination selection button 1102 may provide the user with one or more destination options upon selection. The one or more destination selection options may be based on previously entered destinations, a user profile, collected user information, sponsored locations, place of work, home address, date and time, phone contact addresses, frequent contact addresses, user GPS tracking data, learned user behavior/habits, accessed or inferred calendar/schedule and other predicted, or otherwise suggested destinations. For example, if the user is currently at work and the time is 5 PM on a Wednesday, the top preset destination selection option may be for “home.” If the user is currently at work and the time is 5 PM on a Friday, the top preset destination selection option may be for a local restaurant with happy hour specials that the user frequents. If the user is currently at home on at 7 AM on a weekday, the top preset destination selection option may be for work, while at the same time on the weekend, the top option may be a golf course or breakfast restaurant.

The destination entry button 1103 may allow for a user to speak, type or otherwise select a destination in which they wish to travel. Upon selection of a destination, either through the preset destination selection button 1102, the destination entry button 1103, or though manually scrolling and touching a destination on the map pane 1101, a planned route 1104 may be displayed between the user's current location and the destination. The saved time estimate 1105 may be displayed to the user to show the estimated time saved as well as the estimated price per saved minute. Interface 1100 may also display the free lane travel time 1106 and the booked lane travel time 1107. The free lane travel time 1106 and booked lane travel time 1107 may display the estimated duration of the trip, estimated arrival time and estimated cost. Alternate routes, free lane routes, booked lane routes and hybrid routes, which combine free lane and booked lane segments along the planned route may be displayed for a user to select.

A user may select occupant selection button 1108 to specify the number of occupants in the vehicle. FIG. 11C shows an example of the interface 1100 after the selection of the occupant selection button 1108. The selection may cause the display of an occupant selection pane 1109. The occupant selection pane 1109 may display the estimated cost associated with the number of occupants in the vehicle, as well as an indication of the amount of discount (total amount or percentage saved) the user receives.

As shown in FIG. 11D, after completion of the trip, interface 1100 may display the trip summary 1110 page. Trip summary 1110 may show time saved, total time, difference between estimated commute and actual commute times, cost of the commute, savings per minute, as well as other statistics related to the commute. These additional statistics may include environmental impact information about the commute, such as pounds of carbon dioxide saved, or general commute information, such as number of cars passed.

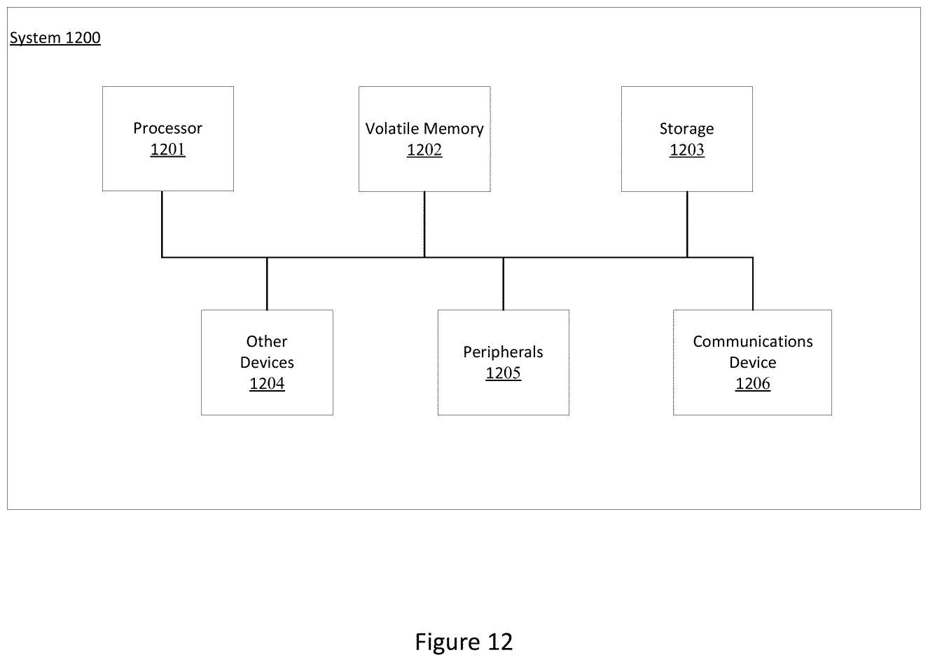

FIG. 12 is a diagram illustrating an exemplary computer that may perform processing in some embodiments. Exemplary computer 1200 may perform operations consistent with some embodiments. The architecture of computer 1200 is exemplary. Computers can be implemented in a variety of other ways. A wide variety of computers can be used in accordance with the embodiments herein. In some embodiments, cloud computing components and/or processes may be substituted for any number of components or processes illustrated in the example.

Processor 1201 may perform computing functions such as running computer programs. The volatile memory 1202 may provide temporary storage of data for the processor 1201. RAM is one kind of volatile memory. Volatile memory typically requires power to maintain its stored information. Storage 1203 provides computer storage for data, instructions, and/or arbitrary information. Non-volatile memory, which can preserve data even when not powered and including disks and flash memory, is an example of storage. Storage 1203 may be organized as a file system, database, or in other ways. Data, instructions, and information may be loaded from storage 1203 into volatile memory 1202 for processing by the processor 1201.

The computer 1200 may include peripherals 1205. Peripherals 1205 may include input peripherals such as a keyboard, mouse, trackball, video camera, microphone, and other input devices. Peripherals 1205 may also include output devices such as a display. Peripherals 1205 may include removable media devices such as CD-R and DVD-R recorders/players. Communications device 1206 may connect the computer 100 to an external medium. For example, communications device 1206 may take the form of a network adapter that provides communications to a network. A computer 1200 may also include a variety of other devices 1204. The various components of the computer 1200 may be connected by a connection medium 1210 such as a bus, crossbar, or network.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed:

1. A method for reserving travel of a vehicle along a route, the method comprising:
receiving, on a client device associated with a user, a travel destination and a user location;
determining an optimal route to the destination from the user location;
identifying one or more highway sections that are reservable along the optimal route;
determining a price estimate for reserving the one or more highway sections in order for the user to travel in a vehicle along the optimal route;
receiving an acceptance of the price estimate from the client device; and
reserving the one or more highway sections for the user based on the price estimate.

2. The method of claim 1, further comprising:
monitoring, via the client device, the travel of the vehicle along the optimal route;
receiving, via the client device, route usage data based on the monitoring of the travel; and
generating aggregate route usage data based on the received route usage data from the client device and additional route usage data from a plurality of additional client devices.

3. The method of claim 2, further comprising:
determining a future price estimate for reserving the highway sections based at least in part on the aggregate route usage data.

4. The method of claim 2, further comprising:
predicting, based on the aggregate route usage data, future traffic conditions along the route; and
determining a future price estimate for reserving the highway sections based at least in part on the predicted future traffic conditions along the route.

5. The method of claim 2, wherein monitoring the travel of the vehicle along the optimal route comprises:
tracking, based on one or more locational sensors in the client device, a location of the vehicle over time along the optimal route.

6. The method of claim 2, wherein the aggregate route usage data comprises traffic throughput and/or lane capacity data for a given time along the route.

7. The method of claim 1, wherein determining the price estimate for reserving the highway sections is based at least in part on estimated time saved due to traveling along the optimal route in the highway sections that are reservable compared to traveling along an alternate route in highway sections that are non-reservable.

8. The method of claim 1, wherein at least one of the highway sections comprises one or more reservable lanes, and
wherein determining the price estimate for reserving the highway sections comprises determining a price estimate for reserving at least one of the reservable lanes.

9. The method of claim 8, wherein determining a price estimate for reserving at least one of the reservable lanes is based at least in part on estimated time saved due to traveling along the optimal route in reservable lanes of the highway sections compared to traveling along the optimal route in non-reservable lanes of the highway sections.

10. The method of claim 1, further comprising:
receiving, via the client device and after reserving the one or more highway sections, a request for modification of the reservation and/or the destination; and
modifying one or more of the reservation, the destination, and the price estimate based on the request for modification.

11. The method of claim 1, further comprising:
determining that a threshold of traffic throughput has been met for one or more of the highway sections; and
determining a future price estimate for reserving the highway sections, wherein the future price estimate is adjusted upwards based at least in part on the threshold of traffic throughput being met.

12. The method of claim 1, wherein determining the price estimate for reserving the highway sections is based at least in part on customer demand for reserving the highway sections.

13. The method of claim 1, further comprising:
determining a minimum baseline of speed for each of the one or more highway sections; and
determining a roadway capacity for each of the one or more highway sections based on the minimum baseline of speed for the highway section,
wherein determining the price estimate for reserving the highway sections is based at least in part on the roadway capacity.

14. A non-transitory computer-readable medium containing instructions for reserving travel of a vehicle along a route, comprising:
instructions for receiving, on a client device associated with a user, a travel destination and a user location;
instructions for determining an optimal route to the destination from the user location;
instructions for identifying one or more highway sections that are reservable along the optimal route;
instructions for determining a price estimate for reserving the one or more highway sections in order for the user to travel in a vehicle along the optimal route;
instructions for receiving an acceptance of the price estimate from the client device; and
instructions for reserving the one or more highway sections for the user based on the price estimate.

15. The non-transitory computer-readable medium of claim 14, further comprising:
instructions for monitoring, via the client device, the travel of the vehicle along the optimal route;
instructions for receiving, via the client device, route usage data based on the monitoring of the travel; and
instructions for generating aggregate route usage data based on the received route usage data from the client device and additional route usage data from a plurality of additional client devices.

16. The non-transitory computer-readable medium of claim 15, further comprising:
instructions for determining a future price estimate for reserving the highway sections based at least in part on the aggregate route usage data.

17. The non-transitory computer-readable medium of claim 15, further comprising:
instructions for predicting, based on the aggregate route usage data, future traffic conditions along the route; and
instructions for determining a future price estimate for reserving the highway sections based at least in part on the predicted future traffic conditions along the route.

18. The non-transitory computer-readable medium of claim 14, wherein determining the price estimate for reserving the highway sections is based at least in part on estimated time saved due to traveling along the optimal route in the highway sections that are reservable compared to traveling along an alternate route in highway sections that are non-reservable.

19. The non-transitory computer-readable medium of claim 14, wherein at least one of the highway sections comprises one or more reservable lanes, and
wherein determining the price estimate for reserving the highway sections comprises determining a price estimate for reserving at least one of the reservable lanes.

20. The non-transitory computer-readable medium of claim 14, further comprising:
instructions for receiving, via the client device and after reserving the one or more highway sections, a request for modification of the reservation and/or the destination; and
instructions for modifying one or more of the reservation, the destination, and the price estimate based on the request for modification.
